(19) United States
(12) Patent Application Publication
(10) Pub. No.: US 2026/0268545 A1
(43) Pub. Date: Sep. 10, 2026

(54) DATA PROCESSING METHOD

(71) Applicant: Tencent Technology (Shenzhen) Company Limited, Shenzhen (CN)

(72) Inventor: Yijie LIN, Shenzhen (CN)

(73) Assignee: Tencent Technology (Shenzhen) Company Limited, Shenzhen, GD (CN)

(21) Appl. No.: 19/661,576

(22) Filed: Apr. 28, 2026

Related U.S. Application Data
(63) Continuation of application No. PCT/CN2025/071208, filed on Jan. 8, 2025.

(30) Foreign Application Priority Data
Jan. 9, 2024 (CN) 202410027118.7

(51) Int. Cl. G06T 11/26; G06F 3/04855; G06T 11/60

(52) U.S. Cl. CPC G06T 11/26; G06T 11/60; G06F 3/04855; G06T 2200/24

(57) ABSTRACT

In a data processing method, a graphic element set is obtained based on original data set, the graphic element set including a plurality of graphic elements and corresponding element positions in a first canvas. In the method, first one or more graphic elements are determined from the graphic element set based on the corresponding one or more element positions satisfying a preset position relationship with a display region. The first one or more graphic elements are drawn on the first canvas. Second one or more graphic elements within the display region are determined. Target original data corresponding to the second one or more graphic elements is obtained from the original data set. The target original data is displayed on a second canvas based on the second one or more graphic elements, a second canvas size of the second canvas corresponding to the display region.

### RELATED APPLICATIONS

The present application is a continuation of International Application No. PCT/CN2025/071208, filed on Jan. 8, 2025, which claims priority to Chinese Patent Application No. 202410027118.7, filed on Jan. 9, 2024 and entitled “DATA PROCESSING METHOD AND APPARATUS, PRODUCT, DEVICE, AND MEDIUM.” The entire disclosures of the prior applications are hereby incorporated by reference.

### FIELD OF THE TECHNOLOGY

This disclosure relates to the field of computer technologies, including data processing methods, apparatuses, and storage media.

### BACKGROUND OF THE DISCLOSURE

A chart (e.g., a chart configured to provide a visualization result of a data set) may be rendered and displayed via associated graphic elements, and the process of rendering and displaying the chart via the graphic elements is a process of drawing and displaying the graphic elements. In related technologies, all graphic elements are drawn on a graphic canvas in a single operation, and all the drawn graphic elements are displayed on the graphic canvas. When there are a large number of graphic elements to be drawn, drawing the graphic elements in this manner is time-consuming, resulting in delay in displaying the graphic elements, and thus leading to poor performance of drawing and displaying the graphic elements.

### SUMMARY

This disclosure provides data processing methods, apparatuses, and storage media to improve the performance of drawing and displaying graphic elements.

An aspect of this disclosure provides a data processing method. In the method, an original data set is obtained. In the method, a graphic element set is obtained based on the original data set, the graphic element set including a plurality of graphic elements and corresponding element positions of the plurality of graphic elements in a first canvas, and a first canvas size of the first canvas being adjustable based on the plurality of graphic elements. In the method, a display region in the first canvas is determined. In the method, first one or more graphic elements are determined by processing circuitry from the graphic element set based on the corresponding one or more element positions of the first one or more graphic elements satisfying a preset position relationship with the display region. In the method, the first one or more graphic elements are drawn on the first canvas based on the corresponding one or more element positions of the first one or more graphic elements. In the method, second one or more graphic elements within the display region are determined by the processing circuitry based on the first one or more graphic elements. In the method, target original data corresponding to the second one or more graphic elements is obtained from the original data set. In the method, the target original data is displayed on a second canvas based on the second one or more graphic elements, a second canvas size of the second canvas corresponding to the display region.

An aspect of this disclosure provides an apparatus for data processing. The apparatus includes processing circuitry configured to obtain an original data set. The processing circuitry is configured to obtain a graphic element set based on the original data set, the graphic element set including a plurality of graphic elements and corresponding element positions of the plurality of graphic elements in a first canvas, and a first canvas size of the first canvas being adjustable based on the plurality of graphic elements. The processing circuitry is configured to determine a display region in the first canvas. The processing circuitry is configured to determine first one or more graphic elements from the graphic element set based on the corresponding one or more element positions of the first one or more graphic elements satisfying a preset position relationship with the display region. The processing circuitry is configured to draw the first one or more graphic elements on the first canvas based on the corresponding one or more element positions of the first one or more graphic elements. The processing circuitry is configured to determine second one or more graphic elements within the display region based on the first one or more graphic elements. The processing circuitry is configured to obtain target original data corresponding to the second one or more graphic elements from the original data set. The processing circuitry is configured to display the target original data on a second canvas based on the second one or more graphic elements, a second canvas size of the second canvas corresponding to the display region.

An aspect of this disclosure provides a non-transitory computer-readable storage medium storing instructions, which when executed by a processor, cause the processor to perform a data processing method. In the method, an original data set is obtained. In the method, a graphic element set is obtained based on the original data set, the graphic element set including a plurality of graphic elements and corresponding element positions of the plurality of graphic elements in a first canvas, and a first canvas size of the first canvas being adjustable based on the plurality of graphic elements. In the method, a display region in the first canvas is determined. In the method, first one or more graphic elements are determined from the graphic element set based on the corresponding one or more element positions of the first one or more graphic elements satisfying a preset position relationship with the display region. In the method, the first one or more graphic elements are drawn on the first canvas based on the corresponding one or more element positions of the first one or more graphic elements. In the method, second one or more graphic elements within the display region are determined based on the first one or more graphic elements. In the method, target original data corresponding to the second one or more graphic elements is obtained from the original data set. In the method, the target original data is displayed on a second canvas based on the second one or more graphic elements, a second canvas size of the second canvas corresponding to the display region.

An aspect of this disclosure provides a data processing method. The method includes: obtaining an original data set, the original data set including at least one item of original data; parsing, based on a first canvas, a graphic element set from the original data set, the graphic element set including a plurality of graphic elements and first element positions respectively allocated to the plurality of graphic elements in the first canvas, and a first canvas size of the first canvas being dynamically adjustable according to the plurality of graphic elements; determining a display region in the first canvas, and screening for a first graphic element from the graphic element set based on the display region and the first element positions respectively corresponding to the plurality of graphic elements, the first element position corresponding to the first graphic element satisfying a preset position relationship with the display region; drawing the first graphic element in the first canvas based on the first element position corresponding to the first graphic element; taking the first graphic element located within the display region as a second graphic element, and determining target original data corresponding to the second graphic element from the original data set; and displaying the target original data in a second canvas by using the second graphic element, a second canvas size of the second canvas corresponding to the display region.

An aspect of this disclosure provides a data processing apparatus. The apparatus includes: an obtaining module, configured to obtain an original data set, the original data set including at least one item of original data; a parsing module, configured to parse, based on a first canvas, a graphic element set from the original data set, the graphic element set including a plurality of graphic elements and first element positions respectively allocated to the plurality of graphic elements in the first canvas, and a first canvas size of the first canvas being dynamically adjustable according to the plurality of graphic elements; a first determining module, configured to determine a display region in the first canvas, and screen for a first graphic element from the graphic element set based on the display region and the first element positions respectively corresponding to the plurality of graphic elements, the first element position corresponding to the first graphic element satisfying a preset position relationship with the display region; a drawing module, configured to draw the first graphic element in the first canvas based on the first element position corresponding to the first graphic element; a second determining module, configured to take the first graphic element located within the display region as a second graphic element, and determine target original data corresponding to the second graphic element from the original data set; and a display module, configured to display the target original data in a second canvas by using the second graphic element, a second canvas size of the second canvas corresponding to the display region.

An aspect of this disclosure provides a computer device, including a memory and a processor. The memory has a computer program stored therein, and the computer program, when executed by the processor, causes the processor to perform the method according to an aspect in this disclosure.

An aspect of this disclosure provides a non-transitory computer-readable storage medium. The non-transitory computer-readable storage medium has a computer program stored therein, and the computer program, when executed by a processor, causes the processor to perform the method according to an aspect in this disclosure.

According to an aspect of this disclosure, a computer program product is provided. The computer program product includes a computer program, and the computer program is stored in a non-transitory computer-readable storage medium. A processor of a computer device reads the computer program from the non-transitory computer-readable storage medium, and the processor executes the computer program, to cause the computer device to perform the method provided in various implementations of the foregoing aspect.

In this disclosure, graphic elements may be drawn on a first canvas. Since a size of the first canvas is dynamically adjustable, graphic elements of any number to be drawn may be accommodated on the dynamically sized first canvas, so that the number of graphic elements to be drawn in this disclosure may be unlimited. In addition, the first canvas may have a display region. In this disclosure, a first graphic element to be currently drawn may be screened from a full graphic element set according to the display region, where a first element position corresponding to the first graphic element in the first canvas satisfies a preset position relationship with the display region. In this way, only the first graphic element associated with the display region needs to be drawn subsequently, without drawing all graphic elements in the graphic element set in a single operation. Then, in a second canvas actually used for displaying original data, target original data may be displayed via a drawn second graphic element located within the display region. Therefore, the efficiency of drawing graphic elements is improved, and the timeliness of displaying graphic elements is enhanced. In some aspects, one or more methods provided in this disclosure may improve the performance of drawing and displaying graphic elements.

### BRIEF DESCRIPTION OF THE DRAWINGS

FIG. 1 is a schematic structural diagram of a network architecture according to an aspect of this disclosure;

FIG. 2 is a schematic diagram of a chart drawing scenario according to an aspect of this disclosure;

FIG. 3 is a schematic flowchart of a data processing method according to an aspect of this disclosure;

FIG. 4a is a schematic diagram of a scenario for dividing a first canvas according to an aspect of this disclosure;

FIG. 4b is a structural schematic diagram of a tree structure according to an aspect of this disclosure;

FIG. 5a is a schematic diagram of an element reuse scenario according to an aspect of this disclosure;

FIG. 5b is a schematic diagram of another element reuse scenario according to an aspect of this disclosure;

FIG. 6 is a schematic diagram of a scenario for obtaining a display position of a graphic element in a second canvas according to an aspect of this disclosure;

FIG. 7 is a schematic architectural diagram of a service architecture for performing graphic element drawing according to an aspect of this disclosure;

FIG. 8 is a schematic logical diagram for displaying original data according to an aspect of this disclosure;

FIG. 9 is a schematic flowchart of a method for obtaining a display region according to an aspect of this disclosure;

FIG. 10 is a schematic interface diagram for displaying a graphic element according to an aspect of this disclosure;

FIG. 11 is a schematic diagram of a scenario for dynamically changing a position of a display region according to an aspect of this disclosure;

FIG. 12 is a schematic flowchart of a method for modifying a graphic element according to an aspect of this disclosure;

FIG. 13 is a schematic structural diagram of a data processing apparatus according to an aspect of this disclosure; and

FIG. 14 is a schematic structural diagram of a computer device according to an aspect of this disclosure.

### DETAILED DESCRIPTION

Examples of terms involved in the aspects of the disclosure are briefly introduced. The descriptions of the terms are provided as examples only and are not intended to limit the scope of the disclosure.

As used in this disclosure, the phrase “at least one of A, B, or C” is intended to mean any one of A, B, or C, or any combination thereof (e.g., A; B; C; A and B; A and C; B and C; or A, B, and C). Similarly, “one of A or B” is intended to include A, B, or both A and B.

Dimension: In the field of data analysis, a dimension may represent a particular feature of data, such as user information or product category. Such features facilitate classification and induction of data. In addition, the dimension may have a plurality of levels. For example, a geographic location may be divided into levels such as province and city. Through such a hierarchical structure, data may be analyzed at different granularities.

Facet: In the field of data analysis, a facet may correspond to a visualization technology that allows displaying different subsets of data in a plurality of subgraphs, so as to better understand the structure and relationship of data. The facet may be configured to explore interactions and influences among a plurality of categorical variables, thereby helping users discover potential patterns and trends in data. The facet technology allows data of a plurality of dimensions to be displayed in a chart.

Visualization rendering engine: On a web side, a visualization rendering engine may correspond to a software component based on a web technology, which is configured to convert data and graphic elements into visual graphics for presentation and interaction in a web browser. Such engines utilize various technical interfaces provided by a web platform to create rich, dynamic, and interactive visual charts, helping users better understand and analyze data. The web-side visualization rendering engine may be performance-optimized for the web platform to help provide a smooth interactive experience even in scenarios with massive data and complex conditions.

Canvas: Canvas may correspond to a graphics drawing technology on the web side, which provides a JavaScript (a programming language)-based drawing application programming interface (API) that allows developers to draw various complex two-dimensional graphics and animations in the web browser. The canvas has favorable cross-platform compatibility and may be used in most modern browsers without installing plug-ins. Developers may control the drawing process on the canvas by writing JavaScript code to realize dynamic and interactive graphic display.

ECharts: ECharts may correspond to an open-source web-side chart library written based on JavaScript, which provides abundant chart types and functions for creating interactive data visualization charts in the web browser. ECharts has favorable cross-platform compatibility and may be used in most modern browsers without installing plug-ins.

Virtual canvas for chart drawing: A virtual canvas may correspond to an abstract region existing in an internal memory and configured to draw chart data. The virtual canvas is not directly displayed on a screen, but exists as an intermediate layer or cache layer for chart drawing. On the virtual canvas, operations such as chart drawing, editing, and layout may be performed without being limited by screen display. By adopting the virtual canvas, the chart drawing efficiency and flexibility may be improved, allowing users to perform complex chart operations in the background and then present the result on a real canvas. A first canvas described below in this disclosure may correspond to a virtual canvas.

Real canvas for chart display: A real canvas may correspond to a chart display region that a user actually sees on a screen. The real canvas is the final destination of chart drawing, and is configured to present chart data on the virtual canvas in a visual form. The real canvas is closely related to user interactions, such as zooming, scrolling, clicking, and other operations, all of which occur on the real canvas. Through the real canvas, a user can intuitively view and analyze chart data to obtain required information and insights. A second canvas described below in this disclosure may correspond to a real canvas.

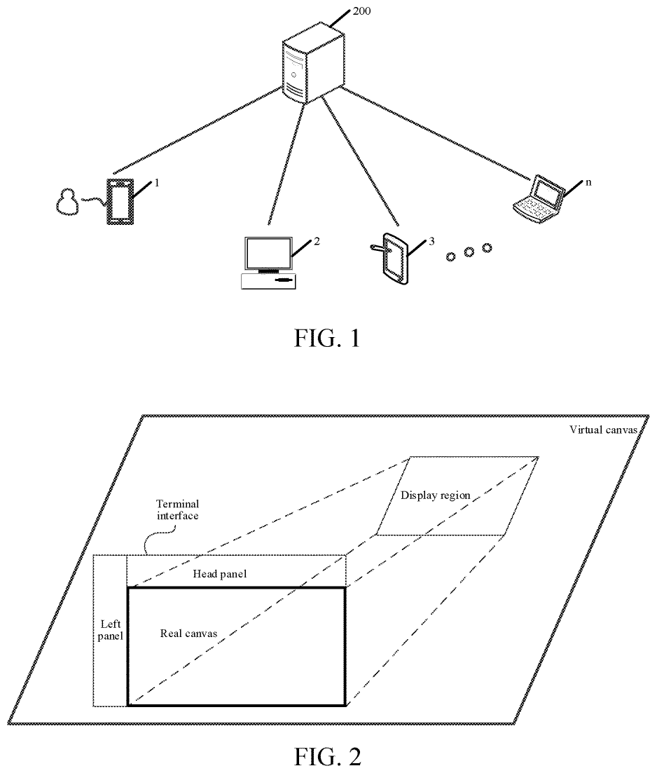

FIG. 1 is a schematic structural diagram of a network architecture according to an aspect of this disclosure. As shown in FIG. 1, the network architecture may include a server 200 and a terminal device cluster. The terminal device cluster may include one terminal device or a plurality of terminal devices. A quantity of terminal devices is not limited herein. As shown in FIG. 1, the plurality of terminal devices may include terminal device 1, terminal device 2, terminal device 3, . . . , and terminal device n. As shown in FIG. 1, terminal device 1, terminal device 2, terminal device 3,. . . , and terminal device n may all be in a network connection with the server 200, so that each terminal device may exchange data with the server 200 through the network connection.

The server 200 shown in FIG. 1 may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal device may be: a smart terminal such as a smartphone, a tablet computer, a laptop computer, a desktop computer, a smart television, a vehicle-mounted terminal, a portable terminal, or a smart home appliance. A description of aspects of this disclosure is given below by taking the communication between terminal device 1 and the server 200 as an example.

Terminal device 1 may be a terminal device for chart drawing. A drawn chart may be configured to display (or present) original data. The original data may be any data to be presented in the form of a chart. For example, the original data may be data such as monthly sales of a merchant. The original data may be provided by the server 200 to terminal device 1. Alternatively, the original data may be local data in terminal device 1. The process of drawing a chart may correspond to a process of rendering the chart. In this disclosure, drawing and rendering may be used interchangeably in some occasions.

FIG. 2 is a schematic diagram of a chart drawing scenario according to an aspect of this disclosure. As shown in FIG. 2, two canvases may be provided in this disclosure. One canvas is a virtual canvas, which may refer to an infinitely expandable drawing space that supports a user to freely draw, edit, and save content without worrying about insufficient canvas space. The virtual canvas may be referred to as a first canvas, which may be a canvas used by a system of terminal device 1 to draw a chart. The other canvas is a real canvas, which refers to a canvas actually used for displaying the drawn chart in a front-end interface. For example, the real canvas may be a canvas including a canvas element of a web side. The real canvas may be referred to as a second canvas, which may be a canvas actually used for displaying, on a terminal interface, the chart drawn in the first canvas.

The chart may include a plurality of graphic elements. The chart is composed of a plurality of graphic elements, and therefore the process of drawing a chart is a process of drawing the graphic elements constituting the chart.

The first canvas may have a display region. A size of the display region may be the same as that of the second canvas. In this disclosure, graphic elements within the display region of the first canvas may be drawn in real time (or in some scenarios, some graphic elements adjacent to but outside the display region may need to be drawn). In addition, a size of the first canvas may be dynamically adjusted to support infinite extension. Therefore, no matter how many graphic elements need to be drawn in total, they may all be drawn on the first canvas. In addition, since only the graphic elements within the display region of the first canvas, or the graphic elements adjacent to but outside the display region, need to be drawn in real time, instead of drawing all graphic elements in a single operation, the drawing performance of the graphic elements will not be affected no matter how many graphic elements need to be drawn in total.

Terminal device 1 may display the graphic elements drawn in the display region of the first canvas in the second canvas in real time. The second canvas may be a canvas for displaying the graphic elements drawn in the display region of the first canvas. The second canvas may be displayed on a terminal interface of terminal device 1. In some aspects, the terminal interface may be a web interface of a web side.

Therefore, based on one or more methods provided by this disclosure, superior performance of drawing and displaying graphic elements in real time may be achieved without limiting the total number of graphic elements to be drawn, and the one or more methods may be applied to various chart rendering and displaying scenarios.

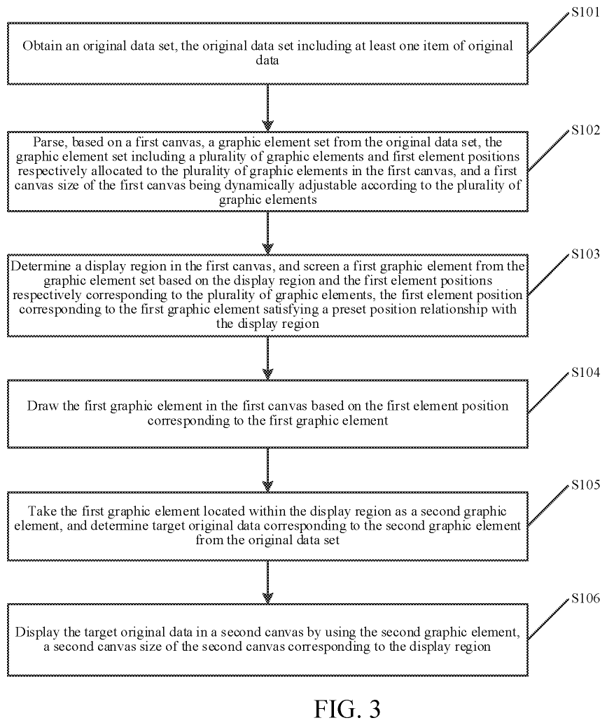

FIG. 3 is a schematic flowchart of a data processing method according to an aspect of this disclosure. In some aspects, the data processing method in FIG. 3 may be executed by a data processing device. The data processing device may be one computer device or a computer device cluster composed of a plurality of computer devices. The computer device may be a terminal device or another device. This is not limited herein. As shown in FIG. 3, the method may include:

Operation S101: Obtain an original data set, the original data set including at least one item of original data.

In an implementation, the data processing device may obtain an original data set. The original data set may include at least one item of original data to be displayed by using a chart. In different application scenarios, a type of the original data in the original data set may be different. According to an actual application scenario, the type of the original data in the original data set may be any type of data to be displayed by using a chart. For example, the chart may be any type of chart such as a bar chart, a line chart, a pie chart, a dot chart, or a bubble chart. In this disclosure, the type of the chart for displaying the original data may be determined according to an actual application scenario. This is not limited in this disclosure.

By way of example, if it is required to display monthly sales of a merchant by using a chart, each item of original data in the original data set may be the monthly sales of the merchant, and one item of original data may be the sales of the merchant for one month. If it is required to display a workload of each employee by using a chart, each item of original data in the original data set may be the workload of each employee, and one item of original data may be the workload of one employee, etc. The number of items of original data in the original data set may be determined according to an actual application scenario.

Operation S102: Parse, based on a first canvas, a graphic element set from the original data set, the graphic element set including a plurality of graphic elements and first element positions respectively allocated to the plurality of graphic elements in the first canvas, and a first canvas size of the first canvas being dynamically adjustable according to the plurality of graphic elements. For example, a graphic element set is determined based on the original data set, the graphic element set including a plurality of graphic elements and corresponding element positions of the plurality of graphic elements in a first canvas, and a first canvas size of the first canvas being adjustable based on the plurality of graphic elements.

In an implementation, the data processing device may parse, based on a first canvas, a graphic element set from the original data set. The graphic element set may include a plurality of graphic elements and element positions respectively allocated to the plurality of graphic elements in the first canvas. The element position corresponding to each graphic element in the first canvas may be referred to as a first element position. The plurality of graphic elements may be configured to draw a chart for showing (or displaying) the original data in the original data set. The chart is composed of a plurality of graphic elements. The corresponding chart may be drawn and displayed by drawing and displaying the graphic elements. The number of graphic elements in the graphic element set may be determined according to an actual application scenario. This is not limited herein.

The first canvas may be a virtual canvas. The first canvas is a canvas for drawing a chart (or drawing the graphic elements). A size of the first canvas may be dynamically adjusted according to the plurality of graphic elements in the graphic element set. For example, the size of the first canvas may be dynamically adjusted to a canvas size capable of accommodating and drawing all the plurality of graphic elements according to a drawing area occupied by the plurality of graphic elements (or an area of a position region to be occupied by the plurality of graphic elements in the first canvas, which may be determined according to the first element positions and sizes corresponding to the plurality of graphic elements). The canvas size of the first canvas may be referred to as a first canvas size. In an example, the first canvas size may be dynamically adjusted according to the plurality of graphic elements.

By way of example, the process of parsing, by the data processing device, a graphic element set from the original data set based on a first canvas may include:

The data processing device may obtain a type of a chart required for displaying original data in the original data set, where the type may be referred to as a target type. By way of example, the target type of the chart required for displaying the original data may be selected by a user in the data processing device. There may be one or more target types. In other words, there may be one or more charts to be drawn and displayed, and the number of charts to be drawn and displayed may be determined according to an actual application scenario.

The data processing device may further obtain configuration data of the chart of the target type. If there are a plurality of target types, one target type may have a corresponding set of configuration data, and different target types may have different configuration data. The configuration data of the chart of the target type may include configuration information of graphic elements for drawing the chart. The configuration information may be configured to indicate how to parse corresponding graphic elements. In an aspect, the configuration information may indicate the type of graphic elements to be parsed and the size of the parsed graphic elements. For example, the graphic elements may be elements for chart drawing such as dots, lines, surfaces, circles, rings, or rectangles.

In addition, if there are a plurality of target types, the original data set may include original data to be displayed by using charts of various target types. In an example, each chart of a target type may have respective corresponding original data in the original data set. The original data corresponding to a chart of a target type is original data to be displayed by using the chart of the target type.

The data processing device may parse the configuration data of the chart of the target type by using the original data set, and generate the plurality of graphic elements in the graphic element set. For example, if the chart of the target type is a bar chart and the original data set includes a sales amount to be displayed by using the bar chart, parsing configuration data of the bar chart by using one sales amount may obtain one bar (e.g., a rectangular bar) associated with the sales amount. The bar may be a graphic element of the bar chart. In some aspects, a width of the bar may be set by default in the configuration data of the bar chart, and a height of the bar may be determined according to a value of the associated sales amount (or a sales amount for parsing the bar). For example, the height of the bar may be configured to represent the value of the associated sales amount. A higher sales amount indicates a greater height of the bar. Conversely, a lower sales amount indicates a smaller height of the bar. A proportional relationship between the height of the bar and the value of the associated sales amount may be configured in the configuration data of the bar chart. Accordingly, when the plurality of graphic elements are parsed by using the original data set and the configuration data of the chart of the target type, the size (or dimension, corresponding to an area to be occupied during subsequent drawing in the first canvas), shape, and the like of the plurality of graphic elements may be determined.

In an actual application scenario, one graphic element in the graphic element set may be parsed based on one or more items of original data in the original data set. Alternatively, in some aspects, the graphic element set may further include some graphic elements that are not parsed by using the original data, but may be directly parsed based on the configuration data. Such graphic elements may be referred to as additional graphic elements. The additional graphic elements may be some fixed graphic elements in the chart selected and drawn by a user, such as coordinate axes in the chart or other default elements for decorating or explaining the chart. The parsed graphic element set may be configured to draw the chart of the target type selected by the user.

If one graphic element in the graphic element set is parsed by using one or more items of original data in the original data set, there may be an association relationship between the graphic element and the one or more items of original data. In some aspects, when parsing the graphic element set, the data processing device may establish the association relationship between each parsed graphic element and each item of original data. In other words, one graphic element may have an association relationship with the original data for parsing the graphic element.

During the process of parsing the plurality of graphic elements in this disclosure, first element positions corresponding to the plurality of graphic elements in the first canvas may be parsed by using the first canvas. Here, corresponding first element positions are allocated to the plurality of graphic elements in the first canvas. At this moment, the plurality of graphic elements are not yet drawn in the first canvas, and the first canvas does not include the plurality of graphic elements. In an example, the graphic element set may further include the parsed first element positions corresponding to the respective graphic elements in the first canvas. One parsed graphic element may have a corresponding first element position on the first canvas, and the first element position corresponding to one graphic element may be a position where the graphic element is subsequently drawn in the first canvas. The first canvas is a canvas for drawing a graphic element (equivalent to drawing a chart), and the first canvas is not a canvas directly used for displaying the original data through the drawn chart on a front-end interface (e.g., a terminal interface).

In an implementation, the first element position of one graphic element may be determined based on a rectangular frame corresponding to the graphic element. For example, the first element position of one graphic element may be a position range of a rectangular frame determined by an element coordinate and a length and width of the graphic element. The element coordinate may be a position coordinate of a top-left corner (or another corner, as long as the position range of the corresponding graphic element in the first canvas may be determined) of the rectangular frame in the first canvas.

The first canvas may have a coordinate system, and the coordinate system may include a coordinate axis in a first direction and a coordinate axis in a second direction. The coordinate axis in the first direction may be referred to as a first coordinate axis, and the coordinate axis in the second direction may be referred to as a second coordinate axis. The first direction may be a horizontal direction. Therefore, the first coordinate axis may be an x-axis (horizontal axis). The second direction may be a vertical direction. Therefore, the second coordinate axis may be a y-axis (vertical axis). The element coordinate for determining the first element position corresponding to the graphic element in the first canvas may be a coordinate in the coordinate system.

The first canvas may be referred to as a virtual canvas, and the size of the first canvas may be infinitely extended (e.g., both the length and width of the first canvas may be infinitely extended). In other words, the first canvas may be a canvas with an infinite size. In an example, the size of the first canvas may be unlimited. The first canvas may exist in a central processing unit (CPU), and the data processing device may draw the graphic elements in the graphic element set in the first canvas. Therefore, the size of the first canvas may be a dynamic size. In an example, the size of the first canvas may be dynamically changed according to an actual application scenario.

In some aspects, if the graphic element set includes graphic elements of a plurality of charts to be drawn, the data processing device may sequentially arrange, in the first canvas, positions of respective charts in the plurality of parsed charts in the first canvas according to a sequence in which the plurality of charts are sequentially selected (e.g., a sequence in which the user sequentially selects the plurality of charts, which are charts selected by the user for displaying the original data before chart parsing and drawing). The charts are sequentially arranged without overlapping or shielding each other. A starting position of a first chart (or the first selected chart and also the first parsed chart) in the first canvas (or a position where drawing of the chart is subsequently started) may be a starting position of the first canvas (e.g., a position with a coordinate (0, 0) in the first canvas). For subsequent charts, a starting position of a next chart may be determined according to a position range occupied by a previous chart in the first canvas. For example, the starting position of the next chart may be a position outside the position range occupied by the previous chart in the first canvas with a particular interval distance (which may be a default interval distance, the interval distance being an interval distance between charts, e.g., a horizontal coordinate interval of 10 or a vertical coordinate interval of 10).

A position range occupied by one chart in the first canvas is a position range occupied by all graphic elements of the chart in the first canvas. Positions of respective graphic elements in one chart may be set by default by a system, e.g., already configured in configuration data of the chart. In other words, a position of each graphic element in one chart and a relative position between respective graphic elements in the chart (e.g., an interval distance between the graphic elements) may be already configured in configuration data of the chart. Therefore, after the starting position of the chart in the first canvas is determined, first element positions corresponding to respective graphic elements of the chart in the first canvas may be deduced (also referred to as parsed) from the starting position according to positions of the respective graphic elements in the chart and relative positions between the respective graphic elements in the chart. The parsed first element positions of the respective graphic elements included in each chart may be configured to subsequently draw (or render) the respective graphic elements included in the chart at corresponding element positions in the first canvas.

For example, if to-be-drawn charts include 5 charts (or there are 5 charts of a target type) and the 5 charts include sequentially selected chart t1, chart t2, chart t3, chart t4, and chart t5, the data processing device may sequentially parse positions of the respective charts on the first canvas according to the sequence in which the respective charts are selected. In an example, the sequence in which the respective charts are selected may be used as a sequence in which the respective charts are parsed, and the sequence may alternatively be a sequence in which the respective charts are arranged in the first canvas. In an example, the respective charts may be regularly arranged sequentially according to the sequence in which the charts are selected.

For example, starting from the starting position of the first canvas (e.g., a top-leftmost position of the first canvas, which may be a position with a coordinate (0, 0)), chart t1 may be first parsed in a position region (which may be a rectangular region) at the top-left corner of the first canvas, where the position region is a region for drawing the chart t1, or a position range where chart t1 is located on the first canvas.

The data processing device may continue to parse a position region where chart t2 is located below the position region where chart t1 is located. The position region where chart t2 is located may be adjacent to the position region where chart t1 is located. In an example, the position region where chart t2 is located may be a position region adjacent below the position region where chart t1 is located. In some aspects, any two adjacent (e.g., neighboring) charts may have a default interval distance (the interval range may be configured by default by the system). The interval distance may be preset by the system according to an actual application scenario. In an example, there may be the interval distance between the position region where chart t2 is located and the position region where chart t1 is located.

Similarly, the data processing device may then continue to parse a position region where chart t3 is located below the position region where chart t2 is located, continue to parse a position region where chart t4 is located below the position region where chart t3 is located, and parse a position region where chart t5 is located below the position region where chart t4 is located. Interval distances between chart t2 and chart t3, between chart t3 and chart t4, and between chart t4 and chart t5 may all be the default interval distance.

Alternatively, in another feasible implementation, a maximum number of charts that may be arranged in one column in the first canvas may be limited. For example, if 3 charts are arranged in one column at most, after chart t1, chart t2, and chart t3 are sequentially arranged and parsed in the first column according to the above principle, remaining charts may be arranged starting from a second column. For example, chart t4 and chart t5 may be sequentially arranged and parsed from the second column (chart t5 may be arranged below chart t4).

Furthermore, if the to-be-drawn charts further include a subsequently selected chart t6 and chart t7 in addition to the 5 charts, a position region where chart t6 is located may be continuously parsed below chart t5 in the second row. So far, the number of charts in the second row also reaches 3. Therefore, a position region where chart t7 is located may be continuously parsed in a third row of the first canvas. If more charts need to be parsed, the process may be deduced by analogy.

Through the foregoing process, first element positions corresponding to respective graphic elements in the graphic element set in the first canvas may be parsed.

The size of the first canvas may be extended (or dynamically adjusted) to a size capable of accommodating the entire graphic element set. The size capable of accommodating the entire graphic element set is a size capable of drawing all graphic elements in the graphic element set (or a size capable of accommodating all charts formed by the graphic elements in the graphic element set), and the size may be referred to as a target size. In other words, the size of the first canvas in this disclosure may be adaptively extended according to a size of an entire region occupied by all selected to-be-drawn charts, and the target size to which the first canvas is extended may be a size capable of accommodating (which may be just capable of accommodating, or may be slightly larger than a just accommodating size, where this may be determined according to an actual application scenario) all the to-be-drawn charts.

Operation S103: Determine a display region in the first canvas, and screen for a first graphic element from the graphic element set based on the display region and the first element positions respectively corresponding to the plurality of graphic elements, the first element position corresponding to the first graphic element satisfying a preset position relationship with the display region. In some examples, first one or more graphic elements are determined by processing circuitry from the graphic element set based on the corresponding one or more element positions of the first one or more graphic elements satisfying a preset position relationship with the display region.

In an implementation, the data processing device may determine a display region in the first canvas. The display region may be a region in the first canvas where graphic elements to be displayed in a front-end interface (e.g., a terminal interface) are located. In some aspects, the display region may be a rectangular region.

The position of the display region in the first canvas may be dynamically changed. The display region in the first canvas obtained here may be a current latest display region in the first canvas, and the current latest display region in the first canvas may be referred to as a target display region. In an example, the display region obtained here may be the target display region. After the position of the display region in the first canvas is changed each time to obtain a new display region, the principle of processing the new display region is the same as the principle of processing the target display region. The target display region may be the latest display region at any moment. For a manner of changing the display region of the first canvas and a manner of determining the position of the changed display region in the first canvas, refer to the relevant description in the aspect corresponding to FIG. 9 below.

In this disclosure, the graphic elements drawn in the display region of the first canvas may be displayed in a second canvas. The second canvas may be an actual canvas for displaying original data by means of drawn charts (equivalent to the drawn graphic elements). A canvas size of the second canvas may be referred to as a second canvas size. The second canvas size of the second canvas may correspond to the display region in the first canvas. For example, the size of the display region of the first canvas may be the same as the size of the second canvas. The second canvas is a real canvas, and the second canvas may be a canvas for actually displaying the drawn graphic elements on the terminal interface. In other words, the second canvas may be configured to display, in the front-end interface, the graphic elements drawn within the display region of the first canvas.

In some aspects, the size of the second canvas may be a fixed size. Alternatively, the size of the second canvas may be a limited size. In an example, the second canvas may have a maximum fixed size. The size of the display region of the first canvas may be determined by the size of the second canvas. For example, the size of the display region of the first canvas may be consistent with (or the same as) the size of the second canvas.

The size of the display region of the first canvas may be smaller than the size of the first canvas (or the size of the display region may be smaller than the target size). Alternatively, in some special cases, the size of the display region of the first canvas may be equal to the size of the first canvas (this case is not the focus of this disclosure).

In some aspects, the sizes of the second canvas in the terminal interfaces of different terminal devices may be the same or different. For example, the size of the second canvas may be a size that corresponds to content display of the terminal device where the second canvas is located. In some aspects, the size of the second canvas may be determined based on the configuration of the terminal device. Alternatively, the size of the second canvas may be fixedly set in advance by relevant developers of the system.

In this disclosure, since the size of the first canvas may be infinitely extended, drawing and displaying may be implemented by means of the first canvas regardless of the number of to-be-drawn charts or the number of graphic elements contained in the charts. In an example, this disclosure imposes no limitation on the number of charts and graphic elements to be drawn, and supports drawing and displaying any number of charts and graphic elements.

In addition, when drawing graphic elements in this disclosure, the graphic elements currently required to be drawn may be screened by means of the display region of the first canvas. The screened graphic elements currently required to be drawn may be referred to as first graphic elements. There may be one or more first graphic elements, and the number of first graphic elements may be determined according to an actual application scenario.

A preset position relationship may be satisfied between the first element position corresponding to the first graphic element and the display region. In this disclosure, the first graphic element may be screened from the graphic element set by means of the preset position relationship, as described below.

The first graphic element may at least include the screened graphic elements having corresponding first element positions located within the display region. Alternatively, in addition, the first graphic element may further include graphic elements having corresponding first element positions located outside the display region but adjacent to the display region. In other words, the first graphic element will include graphic elements having corresponding first element positions located within the display region, and whether the first graphic element further includes other graphic elements (e.g., graphic element having corresponding first element positions located outside the display region but adjacent to the display region) needs to be determined according to an actual application scenario. In actual drawing of graphic elements according to this disclosure, regardless of the number of graphic elements in the graphic element set and how much the size of the first canvas is extended (or regardless of how large the target size is), this disclosure may draw the screened first graphic elements. Therefore, by adopting one or more methods provided in this disclosure, improved performance of drawing the graphic elements in the graphic element set may be achieved.

By way of example, the process of screening for a first graphic element currently required to be drawn from the graphic element set by means of the display region of the first canvas and the first element positions corresponding to the respective graphic elements in the first canvas may include:

The first canvas may be divided into M layers of sub-canvases according to a tree structure, where M is a positive integer, and a value of M may be determined according to an actual application scenario. The tree structure is constructed by progressively dividing the first canvas into sub-canvases layer by layer. As the level of sub-canvases increases, the size of the divided sub-canvases may be smaller. In an example, the division of sub-canvases may be finer, and all sub-canvases at any level may be merged into the entire first canvas. In an example, any sub-canvas at an i^{th} layer may be divided into N sub-canvases at an (i+1)^{th} layer. The N sub-canvases may be next sub-canvases of the any sub-canvas, and the N sub-canvases may have a connection relationship with the any sub-canvas in the tree structure. Therefore, each next sub-canvas of the any sub-canvas belongs to a local canvas within the any sub-canvas. Both i and N are positive integers, and i may be smaller than M. The first canvas may be understood as a special sub-canvas at the first layer among the M layers of sub-canvases. In an example, the first layer of sub-canvas may include the first canvas.

The (i+1)^{th} layer may be any layer other than the last layer among the M layers. The value of N may be determined according to an actual application scenario. For example, if the tree structure adopts a quadtree, N may be equal to 4. In an example, one node (non-leaf node) in the tree structure may be connected to four nodes therebelow, and any node in the tree structure is configured to represent (or may be understood as recording) a corresponding sub-canvas. In an example of this disclosure, N may be equal to 4. In an example, each layer of sub-canvas is divided into four parts. Since such division of sub-canvases is symmetrical and the number of divisions is appropriate, the effect of traversing the sub-canvases may be improved.

Therefore, the data processing device may sequentially traverse the M layers of sub-canvases in the tree structure from top to bottom layer by layer, and may screen for the first graphic element currently required to be drawn from the graphic element set by means of the traversed sub-canvases, the obtained display region (e.g., the target display region) and the element positions corresponding to the respective graphic elements in the first canvas, as described below.

The data processing device may perform an intersection calculation between the traversed sub-canvas and the obtained display region (each time a sub-canvas is traversed, an intersection calculation may be performed between the traversed sub-canvas and the display region), or determine whether there is an intersection (or overlap) between the traversed sub-canvas and the display region. If any traversed sub-canvas at an i^{th} layer (or any sub-canvas at any layer) does not intersect with the display region, indicating that the position of the any sub-canvas is far away from the position of the display region, traversal of next sub-canvases of the any sub-canvas may be stopped. In addition, stopping traversal of the next sub-canvases of the any sub-canvas naturally means that traversal of respective sub-canvases sequentially connected after the next sub-canvases of the any sub-canvas will not be performed.

If any traversed sub-canvas at an i^{th} layer (or any sub-canvas at any layer) intersects with the display region, indicating that the position of the any sub-canvas is close to the position of the display region, traversal of next sub-canvases of the any sub-canvas may be continued, and so on until sub-canvases at an M^{th} layer are traversed.

The data processing device may take, as to-be-drawn sub-canvases, sub-canvases that are traversed in the M^{th} layer of sub-canvas (or the last layer of sub-canvas) and intersect with the display region. There may be one or more to-be-drawn sub-canvases. Therefore, the data processing device may take, as a screened first graphic element, any graphic element having an element position within the to-be-drawn sub-canvas. The first graphic element screened in this manner may include all graphic elements having first element positions within the display region, and may further include graphic elements having first element positions outside the display region but near (also referred to as adjacent to) the display region, because a region formed by merging all to-be-drawn sub-canvases may be slightly larger than the display region but includes the display region.

Accordingly, this disclosure may screen for the first graphic element associated with the target display region by traversing the M layers of sub-canvases and determining whether the traversed sub-canvases intersect with the target display region. In this case, the preset position relationship between the first element position corresponding to the first graphic element and the display region may include: in the M^{th} layer of sub-canvas, a sub-canvas where the first graphic element is located intersects with the display region. In some examples, the preset position relationship corresponds to each one of one or more first graphic elements is located in a sub-canvas in an M^{th} layer of the M layers of sub-canvases that intersects with the display region.

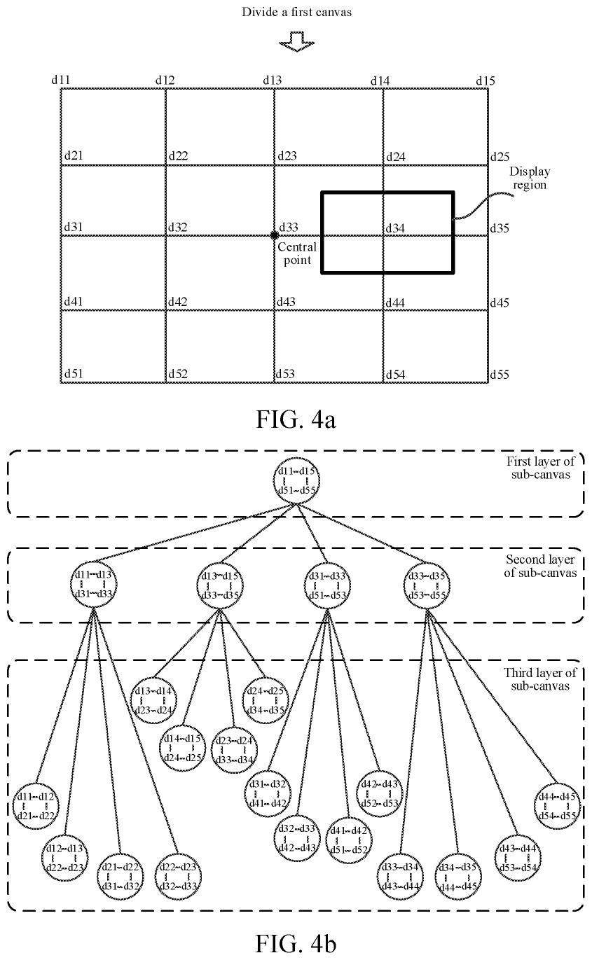

FIG. 4a is a schematic diagram of a scenario for dividing a first canvas according to an aspect of this disclosure. FIG. 4b is a structural schematic diagram of a tree structure according to an aspect of this disclosure. As shown in FIG. 4 a, N may be equal to 4. In an example, the first canvas may be divided into four equal parts, and M may be equal to 3. In an example, the first canvas is divided into three layers of sub-canvases in total.

For convenience of description, vertices (including vertex d11 to vertex d15, vertex d21 to vertex d25, vertex d31 to vertex d35, vertex d41 to vertex d45, and vertex d51 to vertex d55) of respective sub-canvases obtained by dividing the first canvas are introduced for description. However, in an actual processing scenario, the divided sub-canvases may not be recorded and identified by means of vertices of the divided sub-canvases, but by means of other forms. This is not limited in this disclosure. Vertex d33 may be a central point of the first canvas.

As shown in FIG. 4b, the sub-canvases at respective layers may be described more intuitively with reference to FIG. 4b, and each divided sub-canvas may be a rectangular canvas. In an example, the first layer of sub-canvas may be the first canvas. Then, the first canvas may be divided into four equal parts to obtain four sub-canvases in the second layer of sub-canvas. The four sub-canvases may include: sub-canvas B1 of a closed rectangular region formed by sequentially connecting vertex d11, vertex d13, vertex d33, vertex d31, and vertex d11; sub-canvas B2 of a closed rectangular region formed by sequentially connecting vertex d13, vertex d15, vertex d35, vertex d33, and vertex d13; sub-canvas B3 of a closed rectangular region formed by sequentially connecting vertex d31, vertex d33, vertex d53, vertex d51, and vertex d31; and sub-canvas B4 of a closed rectangular region formed by sequentially connecting vertex d33, vertex d35, vertex d55, vertex d53, and vertex d33.

In addition, each of the four sub-canvases in the second layer of sub-canvas may be divided into four equal parts respectively, to obtain next sub-canvases corresponding to respective sub-canvases in the second layer of sub-canvas in the third layer of sub-canvas. For example, the four next sub-canvases obtained by dividing sub-canvas B1 may include: sub-canvas B11 of a closed rectangular region formed by sequentially connecting vertex d11, vertex d12, vertex d22, vertex d21, and vertex d11; sub-canvas B12 of a closed rectangular region formed by sequentially connecting vertex d12, vertex d13, vertex d23, vertex d22, and vertex d12; sub-canvas B13 of a closed rectangular region formed by sequentially connecting vertex d21, vertex d22, vertex d32, vertex d31, and vertex d21; and sub-canvas B14 of a closed rectangular region formed by sequentially connecting vertex d22, vertex d23, vertex d33, vertex d32, and vertex d22.

Similarly, the four next sub-canvases obtained by dividing sub-canvas B2 may include: sub-canvas B21 of a closed rectangular region formed by sequentially connecting vertex d13, vertex d14, vertex d24, vertex d23, and vertex d13; sub-canvas B22 of a closed rectangular region formed by sequentially connecting vertex d14, vertex d15, vertex d25, vertex d24, and vertex d14; sub-canvas B23 of a closed rectangular region formed by sequentially connecting vertex d23, vertex d24, vertex d34, vertex d33, and vertex d23; and sub-canvas B24 of a closed rectangular region formed by sequentially connecting vertex d24, vertex d25, vertex d35, vertex d34, and vertex d24.

In addition, the four next sub-canvases obtained by dividing sub-canvas B3 may include: sub-canvas B31 of a closed rectangular region formed by sequentially connecting vertex d31, vertex d32, vertex d42, vertex d41, and vertex d31; sub-canvas B32 of a closed rectangular region formed by sequentially connecting vertex d32, vertex d33, vertex d43, vertex d42, and vertex d32; sub-canvas B33 of a closed rectangular region formed by sequentially connecting vertex d41, vertex d42, vertex d52, vertex d51, and vertex d41; and sub-canvas B34 of a closed rectangular region formed by sequentially connecting vertex d42, vertex d43, vertex d53, vertex d52, and vertex d42.

In addition, the four next sub-canvases obtained by dividing sub-canvas B4 may include: sub-canvas B41 of a closed rectangular region formed by sequentially connecting vertex d33, vertex d34, vertex d44, vertex d43, and vertex d33; sub-canvas B42 of a closed rectangular region formed by sequentially connecting vertex d34, vertex d35, vertex d45, vertex d44, and vertex d34; sub-canvas B43 of a closed rectangular region formed by sequentially connecting vertex d43, vertex d44, vertex d54, vertex d53, and vertex d43; and sub-canvas B44 of a closed rectangular region formed by sequentially connecting vertex d44, vertex d45, vertex d55, vertex d54, and vertex d44.

Therefore, in this disclosure, the three layers of sub-canvases may be sequentially traversed layer by layer. First, the first canvas in the first layer of sub-canvas is traversed. Since the traversed first canvas intersects with the display region in FIG. 4a, respective next sub-canvases of the first canvas in the second layer of sub-canvas are then traversed. In an example, sub-canvas B1 to sub-canvas B4 may be traversed sequentially. Since sub-canvas B1 and sub-canvas B3 do not intersect with the display region, continuing traversal of respective next sub-canvases of sub-canvas B1 and sub-canvas B3 in the third layer of sub-canvas is unnecessary, so that the workload of sub-canvas traversal may be reduced. In addition, since sub-canvas B2 and sub-canvas B4 intersect with the display region, respective next sub-canvases of sub-canvas B2 and respective next sub-canvases of sub-canvas B4 in the third layer of sub-canvas may be continuously traversed. In an example, sub-canvas B21 to sub-canvas B24 are traversed, and sub-canvas B41 to sub-canvas B44 are traversed.

Since the third layer of sub-canvas is the last layer of sub-canvas, sub-canvas B23, sub-canvas B24, sub-canvas B41, and sub-canvas B42 that intersect with the display region, among sub-canvas B21 to sub-canvas B24 and sub-canvas B41 to sub-canvas B44 traversed in the third layer of sub-canvas, may be taken as to-be-drawn sub-canvases, so that graphic elements having first element positions within sub-canvas B23, sub-canvas B24, sub-canvas B41, and sub-canvas B42 may be taken as the screened first graphic elements.

By sequentially traversing and screening the divided sub-canvases layer by layer instead of directly traversing all respective graphic elements, the efficiency of screening graphic elements in the display region may be improved.

Alternatively, in some aspects, if the obtained display region (e.g., the target display region) has no previous display region, the target display region may be a display region obtained initially (e.g., for the first time) in the first canvas (the target display region is a display region that has not been changed at the very beginning, which may be referred to as an initial display region, and the initial display region may be a region at a topmost left part in the first canvas, e.g., a top-left corner of the initial display region may coincide with a top-left corner of the first canvas), this disclosure may adopt the foregoing procedure to screen for the first graphic element by traversing the M layers of sub-canvas and determining whether the traversed sub-canvases intersect with the target display region.

If the obtained display region (e.g., the target display region) has a previous display region, the target display region may not be a display region obtained initially (e.g., for the first time) in the first canvas (for example, the target display region is not the foregoing initial display region), in other words, the target display region is a display region obtained after changing (the number of changes is not limited) based on the display region obtained for the first time, when screening for graphic elements associated with the target display region (e.g., screening for the first graphic element by using the target display region), this disclosure may reuse graphic elements that have been drawn in the previous display region of the target display region before, so as to further improve the efficiency of drawing graphic elements and improve the timeliness of displaying graphic elements. The previous display region of the target display region may be a display region before the display region in the first canvas is changed to the target display region. More specifically, the previous display region of the target display region may be a latest display region before the display region in the first canvas is changed to the target display region. In some aspects, the target display region may be obtained after the previous display region is changed once again.

In this case (or in a case that the target display region has a previous display region), the process of screening for a first graphic element to be drawn from the graphic element set by using the target display region and first element positions corresponding to respective graphic elements in the graphic element set in the first canvas may include: the data processing device may screen for a first graphic element currently required to be drawn from the graphic element set by using the target display region and the previous display region of the target display region, as described below.

The data processing device may obtain an overlapping region between the target display region and the previous display region. In an example, both the target display region and the previous display region include the overlapping region, and a region other than the overlapping region in the target display region may be taken as an update region. The update region is also an incremental region of the target display region compared with the previous display region.

Further, the data processing device may screen for the first graphic element from the graphic element set by using the update region in the first canvas and first element positions corresponding to respective graphic elements in the first canvas. In some aspects, the process may be the same as the foregoing principle of screening for the first graphic element by traversing M layers of sub-canvases and determining whether the traversed sub-canvases intersect with the target display region. Here, the first graphic element may be screened by traversing the M layers of sub-canvases layer by layer and determining whether the traversed sub-canvases intersect with the update region. The first graphic element screened in this manner may include graphic elements having first element positions within sub-canvases that are traversed in an M^{th} layer of sub-canvas and intersect with the update region. In this case, the preset position relationship between the first element position corresponding to the first graphic element and the display region may include: in the M^{th} layer of sub-canvas, a sub-canvas where the first graphic element is located intersects with the update region in the display region.

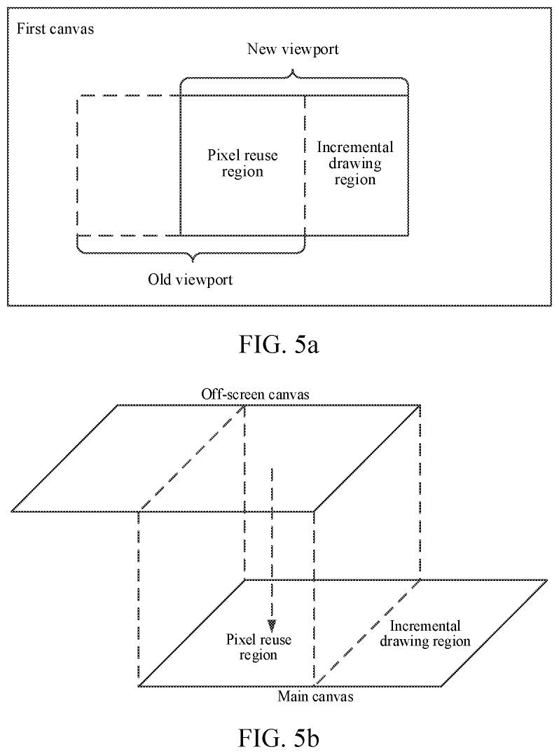

FIG. 5a is a schematic diagram of an element reuse scenario according to an aspect of this disclosure. FIG. 5b is a schematic diagram of another element reuse scenario according to an aspect of this disclosure. As shown in FIG. 5a, an old viewport may be a previous display region of the foregoing target display region, and a new viewport may be a target display region. There is an overlapping region between the target display region and the previous display region, and the overlapping region may be a pixel reuse region in FIG. 5a. The pixel reuse region is a region where relevant graphic elements drawn for the previous display region may be reused. The region in the new viewport other than the pixel reuse region (or an incremental drawing region) may be the foregoing update region.

Drawing a graphic element may include generating each pixel point (which may be referred to as a pixel for short) constituting the graphic element. Each pixel point may have a respective pixel value and pixel position. The pixel position may be a position where the corresponding pixel point needs to be drawn in the first canvas. In an example, the pixel position may be a position where the corresponding pixel point is located in the first canvas.

Therefore, in this disclosure, each pixel point located within the pixel reuse region that has been drawn in the previous display region may be reused within the pixel reuse region.

In the pixel reuse process of this disclosure, there may be two concepts: a main canvas and an off-screen canvas. The main canvas may be configured to draw graphic elements for actual display to a user, and the main canvas may be mounted on an html (a markup language) document. The off-screen canvas may not be mounted on the document, and the off-screen canvas may be an element configured to store pixel information (e.g., information of each pixel point drawn within the display region and constituting the graphic element, where the information may include a pixel value and a pixel position of the pixel point), and is not configured for actual display on a screen (e.g., a terminal interface).

As shown in FIG. 5b, in this disclosure, each pixel point generated in the pixel reuse region of the previous display region in the off-screen canvas may be reused into the pixel reuse region of the target display region in the main canvas, and graphic elements within the incremental drawing region of the target display region in the main canvas may be drawn in real time, to realize drawing and display of the graphic elements within the target display region.

Through the foregoing process, the first graphic element currently required to be drawn may be screened. The screened first graphic element may be graphic elements having element positions located in a sub-canvas intersecting with the target display region in the M^{th} layer of sub-canvas (or graphic elements associated with the target display region), or the screened first graphic element may be a graphic element having an element position located in a sub-canvas intersecting with the update region in the M^{th} layer of sub-canvas (or a graphic element associated with the update region).

In this disclosure, by adopting a tree structure to traverse sub-canvases, graphic elements associated with the target display region or the update region may be quickly screened from a large number of graphic elements in the graphic element set. In some aspects, the first graphic element currently required to be drawn may be quickly screened.

In some aspects, if the number of graphic elements in the graphic element set is not large (e.g., less than a preset reference number) and graphic elements associated with the target display region need to be obtained, each graphic element in the graphic element set may be directly traversed, and intersection calculation may be performed between the traversed graphic element and the target display region (or intersection calculation is performed between a first element position corresponding to the graphic element and the target display region to determine whether a position region occupied by the graphic element in the first canvas intersects with the target display region, or whether there is an overlap). The graphic element intersecting with the target display region (or the graphic element having a corresponding first element position intersecting with the target display region) may be taken as the screened first graphic element. At this moment, the screened first graphic element may include graphic elements within the target display region, and does not include graphic elements outside the target display region. In this case, the preset position relationship between the first element position corresponding to the first graphic element and the display region may include: the first element position corresponding to the first graphic element is located within the display region.

Similarly, if the number of graphic elements in the graphic element set is not large (e.g., less than a preset reference number) and graphic elements associated with the update region need to be obtained, each graphic element in the graphic element set may be directly traversed, intersection calculation may be performed between the traversed graphic element and the update region, and the graphic element intersecting with the update region may be taken as the screened first graphic element. In this case, the screened first graphic element may include all graphic elements within the update region.

Operation S104: Draw the first graphic element in the first canvas based on the first element position corresponding to the first graphic element. For example, the first one or more graphic elements are drawn on the first canvas based on the corresponding one or more element positions of the first one or more graphic elements.

In an implementation, the data processing device may draw (or render) the first graphic element at the first element position corresponding to the first graphic element in the first canvas. In an example, each first graphic element may be drawn at the corresponding first element position in the first canvas.

Operation S105: Take the first graphic element located within the display region as a second graphic element, and determine target original data corresponding to the second graphic element from the original data set. In some examples, second one or more graphic elements within the display region are determined by the processing circuitry based on the first one or more graphic elements. In some examples, target original data corresponding to the second one or more graphic elements is obtained from the original data set.

In an implementation, all drawn first graphic elements located within the display region may be referred to as second graphic elements. In some aspects, the second graphic elements may be part of the first graphic elements, or the second graphic elements may be all the first graphic elements.

If the first graphic element is a screened graphic element associated with the target display region (e.g., a graphic element within a sub-canvas intersecting with the target display region in an M^{th} layer of sub-canvas), the second graphic element may include graphic elements drawn within the entire target display region.

If the first graphic element is a screened graphic element associated with the update region (e.g., a graphic element within a sub-canvas intersecting with the update region in an M^{th} layer of sub-canvas), the second graphic element may include graphic elements drawn within the entire update region.

The data processing device may further determine target original data corresponding to the second graphic element from the original data set. The target original data is screened original data currently required to be displayed (or shown) from the original data set. The target original data may be original data having an association relationship with the second graphic element in the original data set. In an example, the second graphic element may be obtained by parsing the target original data, and the target original data may be displayed by the drawn second graphic element. There may be one or more pieces of target original data, and a number of the target original data may be determined according to an actual application scenario.

Through the foregoing process, this disclosure may screen for the second graphic element required to be displayed in the second canvas in two operations, or may screen for the second graphic element required to be displayed in the second canvas in one operation. For example, in the foregoing manner of first screening for the first graphic element by using M layers of sub-canvases and then screening for the second graphic element, since the first graphic element may include graphic elements outside the target display region, the second graphic element needs to be screened in two operations. In some aspects, the second graphic element needs to be further screened from the first graphic element. In the foregoing manner of directly traversing the graphic elements in the graphic element set to directly screen for the first graphic element within the target display region, since the first graphic element does not include graphic elements outside the target display region, the second graphic element may be directly obtained in one operation. In some aspects, the first graphic element may be directly taken as the second graphic element without further screening for the second graphic element from the first graphic element.

Operation S106: Display the target original data in a second canvas by using the second graphic element, a second canvas size of the second canvas corresponding to the display region. For example, the target original data is displayed on a second canvas based on the second one or more graphic elements, a second canvas size of the second canvas corresponding to the display region.

In an implementation, the data processing device may display the target original data in the second canvas by using the drawn second graphic element. For example, the target original data and the second graphic element may be displayed in association in the second canvas. The target original data may be displayed beside (or nearby) the second graphic element, or the target original data may be displayed inside the second graphic element. The drawn second graphic element may form part of a drawn chart. The second graphic element and the target original data may be displayed simultaneously in the second canvas. For example, if one piece of target original data is a sales amount and the second graphic element having an association relationship with the target original data is a bar, the sales amount may be displayed above the bar in the second canvas. For another example, if one piece of target original data is a sales amount and the second graphic element having an association relationship with the target original data is a sector, the sales amount may be displayed inside the sector in the second canvas. The second canvas is an actual canvas for displaying, in a front-end interface, the graphic elements drawn within the display region of the first canvas. The size (or dimension) of the display region in the first canvas may be the same as the size of the second canvas.

If the first graphic element is a screened graphic element associated with the target display region (e.g., a graphic element within a sub-canvas intersecting with the target display region in an M^{th} layer of sub-canvas), the entire second canvas may be fully configured to display the second graphic element and the target original data.

If the first graphic element is a screened graphic element associated with the update region (e.g., a graphic element in a sub-canvas intersecting with the update region in an M^{th} layer of sub-canvas), the data processing device may display, in the second canvas, the drawn second graphic element located within the update region and the target original data. The data processing device may display, in the second canvas, graphic elements already drawn (which may be referred to as drawn graphic elements) before within the overlapping region (or an overlapping region between the target display region and the previous display region of the target display region) of the previous display region of the target display region and original data associated with the drawn graphic elements. The original data associated with the drawn graphic elements is original data having an association relationship with the drawn graphic elements.

In other words, when changing from the previous display region to the target display region, the graphic elements within the overlapping region between the target display region and the previous display region do not need to be redrawn repeatedly. The graphic elements already drawn within the overlapping region of the previous display region may be directly reused, thereby reducing overhead for drawing graphic elements and improving efficiency of drawing and displaying graphic elements.

Alternatively, in an implementation, a corresponding graphic element obtained by parsing original data may include the original data or may be configured to indicate the original data. Therefore, in such a case, a drawn graphic element may be directly displayed in the second canvas without additionally displaying the original data having an association relationship with the drawn graphic element. Configuration may be flexibly performed according to an actual application scenario. This is not limited in this disclosure.

A display manner of the second graphic element in the second canvas may be the same as a display manner of the second graphic element within the display region of the first canvas.

Alternatively, in another implementation, when displaying the second graphic element in the second canvas, the display manner (or a manner in which the drawn second graphic element is presented in the first canvas) of the second graphic element may be adjusted first, so as to display the target original data in the second canvas by using the adjusted second graphic element. In an example, the adjusted second graphic element is displayed in the second canvas. In such a case, the manner in which the second graphic element is displayed in the second canvas may be different from the manner in which the second graphic element is presented within the display region of the first canvas. For example, a color or style (e.g., a cartoon style, a sketch style, etc.) of the second graphic element may be adjusted, so that the second graphic element is adjusted to a color or a style. Therefore, the target original data may be displayed in the second canvas by using the second graphic element subjected to color adjustment or style adjustment. Furthermore, if the display style of the second graphic element is adjusted, the target original data may be displayed in the second canvas in the same style as the adjusted style of the second graphic element. A display manner of the second graphic element in the second canvas may be set independently according to actual application requirements.

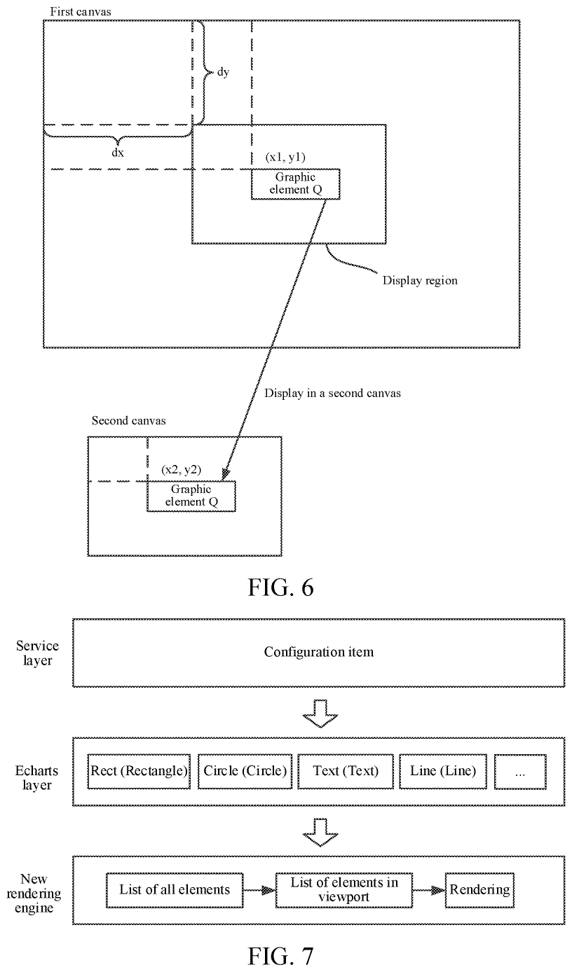

FIG. 6 is a schematic diagram of a scenario for obtaining a display position of a graphic element in a second canvas according to an aspect of this disclosure. As shown in FIG. 6, a first canvas and a second canvas may be in different coordinate systems. A display position of a graphic element in the second canvas may be an element position corresponding to the graphic element in the second canvas. The element position corresponding to the graphic element in the second canvas may be referred to as a second element position. The second element position may be a position region where the graphic element is located in the second canvas. In some aspects, an origin of the coordinate system of the first canvas may be at a bottom-left corner (or a bottom-left vertex) of the first canvas. An origin of the coordinate system of the second canvas may be at a bottom-left corner (or a bottom-left vertex) of the second canvas.

Therefore, if a display region of the first canvas includes graphic element Q, position coordinates of graphic element Q in the coordinate system of the first canvas may be (x1, y1). Values of x1 and y1 may be determined according to an actual application scenario. The position coordinates (x1, y1) may be position coordinates of a top-left corner (or a top-left vertex) of a rectangular region where graphic element Q is located in the first canvas. A distance from the top-left corner (or the top-left vertex) of the display region in the first canvas to an upper edge (or an upper boundary) of the first canvas may be dy. A distance from the top-left corner (or the top-left vertex) of the display region in the first canvas to a left edge (or a left boundary) of the first canvas may be dx. Therefore, a corresponding display position of graphic element Q in the second canvas may be a position indicated by position coordinates (x1-dx, y1-dy). For example, a position region (which may be a rectangular region) where graphic element Q is located in the second canvas and indicated by the position coordinates and a width and height of graphic element Q. The width and height of graphic element Q may be known when graphic element Q is parsed. The position coordinates (x1-dx, y1-dy) may be position coordinates of the top-left corner (or the top-left vertex) of the rectangular region where graphic element Q is located in the second canvas. In an example, a horizontal coordinate of the top-left corner of the rectangular region where graphic element Q is located in the second canvas may be a difference obtained by subtracting dx from x1. A vertical coordinate of the top-left corner of the rectangular region where graphic element Q is located in the second canvas may be a difference obtained by subtracting dy from y1.

Each graphic element drawn within the display region of the first canvas may be displayed at a corresponding position in the second canvas according to the foregoing principle.

FIG. 7 is a schematic architectural diagram of a service architecture for performing graphic element drawing according to an aspect of this disclosure. As shown in FIG. 7, a service architecture of this disclosure may include a service layer, an Echarts layer, and a rendering engine. The service layer may provide configuration items of a chart. The configuration items may be various configuration items, in configuration data of the chart, corresponding to the chart to which the configuration items belong.

The Echarts layer may obtain (e.g., parse) various graphic elements (which may include various graphic elements in the foregoing graphic element set) that constitute the chart and are recognizable by the rendering engine based on an Echarts chart library tool. The graphic elements may include graphic elements such as Rect (rectangle), Circle (circle), Text (text), and Line (line).

In addition, the rendering engine originally applied to Echarts may be replaced with a new rendering engine provided by this disclosure. The new rendering engine of this disclosure may be configured to draw graphic elements on a virtual canvas (or the first canvas). When drawing graphic elements, the new rendering engine may be configured to draw, in real time, graphic elements within the display region of the virtual canvas or adjacent to the display region, and may display the graphic elements drawn in the virtual canvas to an actual canvas (or the second canvas) in real time.

Therefore, the new rendering engine may obtain a list of all elements. The list of all elements corresponds to the foregoing graphic element set. The list of all elements may include graphic elements of all charts to be drawn. The new rendering engine of this disclosure may screen for a list of elements in viewport from the list of all elements. The list of elements in viewport may include the first graphic element required to be drawn, which is screened based on the display region of the first canvas. Then, the new rendering engine may render (or draw) the graphic elements in the list of elements in viewport according to the method described above.

In some aspects, without limiting the total number of charts and graphic elements that may be drawn, this disclosure draws graphic elements within the display region or adjacent to the display region. The overall performance of drawing graphic elements is not affected. Therefore, one or more methods in this disclosure may enhance performance of drawing and displaying charts.

Moreover, in related technologies, when visual analysis of large data, multiple dimensions, and multiple facets is implemented on a web side of a browser, a large number of charts need to be drawn in a single operation. Since the number of these charts may reach tens of thousands, a large number of graphic elements need to be generated in a single operation, resulting in lag or crash of the browser. In addition, the canvas of the browser has a limit on a total pixel size of graphic elements to be rendered, so that the browser may be unable to perform drawing when there are many charts. Therefore, one or more methods in this disclosure provide a visual rendering engine that addresses both problems simultaneously. The visual rendering engine of this disclosure may quickly draw tens of thousands of charts without being limited by the browser pixel size and without lag.

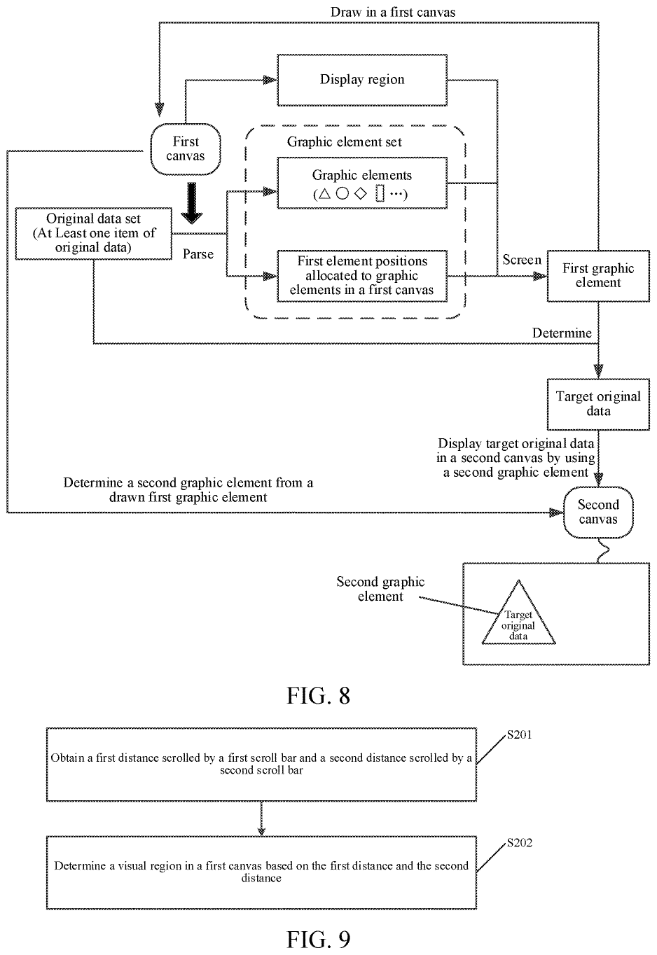

FIG. 8 is a schematic logical diagram for displaying original data according to an aspect of this disclosure. As shown in FIG. 8, this disclosure may parse a graphic element set from an original data set based on a first canvas. The graphic element set includes a plurality of parsed graphic elements and first element positions allocated to the respective graphic elements in the first canvas. The data processing device may screen for a first graphic element from the plurality of graphic elements according to the first element positions corresponding to the respective graphic elements in the first canvas and a position of a display region in the first canvas. A preset position relationship may be satisfied between the first element position corresponding to the graphic element and the display region. The data processing device may draw the first graphic elements in the first canvas, and may take a first graphic element located within the display region among the drawn first graphic elements as a second graphic element. The data processing device may further determine target original data corresponding to the second graphic element from an original data set. Therefore, the target original data corresponding to the second graphic element may be displayed via the second graphic element in a second canvas. For example, the target original data may be displayed within the second graphic element in the second canvas. Alternatively, in an actual application scenario, the target original data may be displayed outside the second graphic element at a position adjacent to the second graphic element.

In this disclosure, graphic elements may be drawn on a first canvas. Since a size of the first canvas is dynamically adjustable, graphic elements of any number to be drawn may be accommodated on the dynamically sized first canvas, so that the number of graphic elements to be drawn in this disclosure may be unlimited. In addition, the first canvas may have a display region. In this disclosure, a first graphic element to be currently drawn may be screened from a full graphic element set according to the display region, where a first element position corresponding to the first graphic element in the first canvas satisfies a preset position relationship with the display region. In this way, only the first graphic element associated with the display region needs to be drawn subsequently, without drawing all graphic elements in the graphic element set in a single operation. Then, in a second canvas actually used for displaying original data, target original data may be displayed via a drawn second graphic element located within the display region. Therefore, the efficiency of drawing graphic elements is improved, and the timeliness of displaying graphic elements is enhanced. In some aspects, one or more methods provided in this disclosure may improve the performance of drawing and displaying graphic elements.

FIG. 9 is a schematic flowchart of a method for obtaining a display region according to an aspect of this disclosure. As shown in FIG. 9, the method may include:

Operation S201: Obtain a first distance scrolled by a first scroll bar and a second distance scrolled by a second scroll bar.

In an implementation, the second canvas may be displayed on a terminal interface, and the terminal interface may further include (e.g., display) a first scroll bar and a second scroll bar. The first scroll bar may be configured to perform a scroll change on the display region of the first canvas in a first direction (e.g., a horizontal direction) (which may be understood as performing a scroll change on the position of the display region on a first coordinate axis (e.g., a horizontal axis)). The second scroll bar may be configured to perform a scroll change on the display region of the first canvas in a second direction (e.g., a vertical direction) (which may be understood as performing a scroll change on the position of the display region on a second coordinate axis (e.g., a vertical axis)).

The target size to which the first canvas is extended may include a size to which the first canvas is extended in the first direction and a size to which the first canvas is extended in the second direction. The size to which the first canvas is extended in the first direction may be a length to which the first canvas is extended. The size to which the first canvas is extended in the second direction may be a width to which the first canvas is extended.

A total scroll distance of the first scroll bar (which may be understood as a total length of the first scroll bar) may be equal to the size to which the first canvas is extended in the first direction, namely, the length of the first canvas. A total scroll distance of the second scroll bar (which may be understood as a total length of the second scroll bar) may be equal to the size to which the first canvas is extended in the second direction, namely, the width of the first canvas.

Therefore, graphic elements at various element positions in the first canvas may be scrolled and displayed in the first direction by using the first scroll bar, and graphic elements at various element positions in the first canvas may be scrolled and displayed in the second direction by using the second scroll bar. Graphic elements at all element positions in the first canvas may be scrolled and displayed by combining the first scroll bar and the second scroll bar.

From the above, a user is supported to scroll the first scroll bar and the second scroll bar (the two scroll bars may be scrolled independently respectively) on the terminal interface, to display different graphic elements drawn at different positions of the first canvas. In practice, the user does not need to perceive the existence of the first canvas. From the perception of the user, the user may perceive that charts at different positions may be displayed by using the first scroll bar and the second scroll bar.

Therefore, the data processing device may obtain a current scroll distance of the first scroll bar (which may be referred to as a first distance), and may obtain a current scroll distance of the second scroll bar (which may be referred to as a second distance).

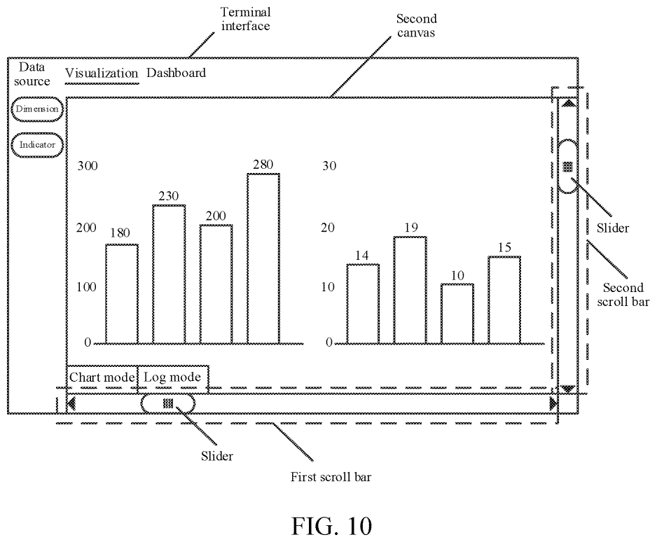

FIG. 10 is a schematic interface diagram for displaying a graphic element according to an aspect of this disclosure. As shown in FIG. 10, a second canvas of this disclosure may be displayed on a terminal interface, and graphic elements drawn within a display region of a first canvas may be displayed in the second canvas. The terminal interface may further include a first scroll bar and a second scroll bar. The first scroll bar may be provided with a slider, and the slider is supported to be scrolled on the first scroll bar, so as to perform a scroll change on a position of the display region in the first canvas in a horizontal direction. Similarly, the second scroll bar may be provided with a slider, and the slider is supported to be scrolled on the second scroll bar, so as to perform a scroll change on the position of the display region in the first canvas in a vertical direction.

Operation S202: Determine a display region in a first canvas based on the first distance and the second distance.

In an implementation, the data processing device may obtain a first coordinate value by using the first distance. The first coordinate value may be configured to indicate, on a first coordinate axis, a position of the current display region in the first canvas. In some aspects, the first coordinate value may be a horizontal coordinate in a coordinate system.

In addition, the data processing device may further obtain a second coordinate value by using the second distance. The second coordinate value may be configured to indicate, on a second coordinate axis, a position of the current display region in the first canvas. In some aspects, the second coordinate value may be a vertical coordinate in a coordinate system.

In an example, the data processing device may obtain an initial coordinate value of the display region of the first canvas in the first direction (which may be referred to as a first initial coordinate value). The first initial coordinate value may be a horizontal coordinate indicating a position, on the first coordinate axis, of the display region of the first canvas in an initial unchanged state. For example, the first initial coordinate value may be a horizontal coordinate of a top-left corner (or a top-left vertex) of the display region of the first canvas in the initial unchanged state.

Further, the data processing device may perform summation processing (or addition calculation) on the first initial coordinate value and the first distance, so as to obtain the first coordinate value. Correspondingly, the first coordinate value may be a horizontal coordinate of a top-left corner of the current display region (e.g., a target display region).

Similarly, the data processing device may further obtain an initial coordinate value of the display region of the first canvas in the second direction (which may be referred to as a second initial coordinate value). The second initial coordinate value may be a vertical coordinate for indicating a position, on the second coordinate axis, of the display region of the first canvas in an initial unchanged state. For example, the second initial coordinate value may be a vertical coordinate of a top-left corner (or a top-left vertex) of the display region of the first canvas in the initial unchanged state.

Further, the data processing device may perform summation processing (or addition calculation) on the second initial coordinate value and the second distance, so as to obtain the second coordinate value. Correspondingly, the second coordinate value may be a vertical coordinate of a top-left corner of the current display region (e.g., a target display region).

Furthermore, the data processing device may construct a target coordinate in the coordinate system where the first canvas is located by using the first coordinate value and the second coordinate value obtained above. A horizontal coordinate in the target coordinate may be the first coordinate value, and a vertical coordinate in the target coordinate may be the second coordinate value. The target coordinate may be a position coordinate, in the coordinate system, of a top-left corner of the current display region (e.g., a top-left vertex of a rectangular region of the display region).

Therefore, a region position, in the first canvas, of the current display region (e.g., the target display region) of the first canvas may be uniquely determined by combining the target coordinate and a size of the display region (which may include a length and width of the display region). In some aspects, the position of the display region in the first canvas in this disclosure supports dynamic change, but the size of the display region may not change during the dynamic change of the position of the display region.

In some aspects, in an actual application scenario, the target coordinate may be any coordinate for positioning the display region in the first canvas. For example, the target coordinate may be a position coordinate of any vertex of the current display region in the first canvas. Therefore, a rectangular region where the current display region is located in the first canvas may be uniquely determined by using one coordinate (or the target coordinate) for positioning the display region of the first canvas, in combination with a length of the display region in the horizontal direction and a width of the display region in the vertical direction.

In another feasible implementation, there may be only one scroll bar configured to perform a scroll change on the position of the display region in the first canvas, for example, only a scroll bar in the vertical direction. In such a case, the size of the display region in the horizontal direction may be equal to the size to which the first canvas is extended in the horizontal direction, and the position of the display region in the first canvas in the horizontal direction does not need to be subjected to scroll change, and only the position of the display region in the vertical direction needs to be subjected to scroll change.

The converse is also true. There may be only a scroll bar in the horizontal direction. In such a case, the size of the display region in the vertical direction may be equal to the size to which the first canvas is extended in the vertical direction, and the position of the display region in the first canvas in the vertical direction does not need to be subjected to scroll change, and only the position of the display region in the horizontal direction needs to be subjected to scroll change.

Alternatively, the scroll bar is one form configured to perform a scroll change on the position of the display region in the first canvas. In more implementations, the position of the display region in the first canvas may be dynamically changed in other forms, and the position of the display region in the first canvas does not necessarily need to be dynamically changed by using the scroll bar. This is not limited in this disclosure.

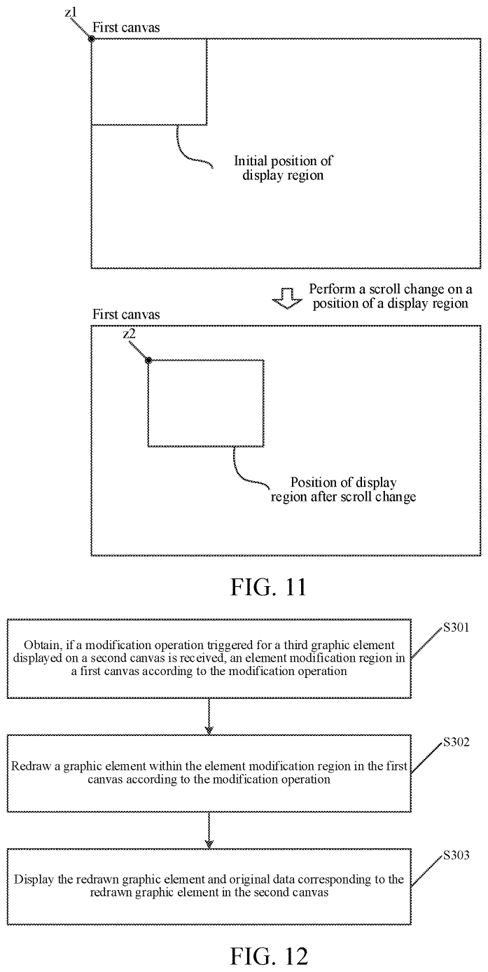

FIG. 11 is a schematic diagram of a scenario for dynamically changing a position of a display region according to an aspect of this disclosure. As shown in FIG. 11, an initial position of a display region in a first canvas may be a top-left region position of the first canvas (e.g., a position of a top-left corner of the display region at the initial position may be position Z1 at a top-left corner of the first canvas). Through an operation of a user to dynamically change the display region on a terminal interface (e.g., performing a scroll change by using a scroll bar), the display region in the first canvas may be dynamically changed to another position in the first canvas. For example, the position of the top-left corner of the display region may be changed to position Z2 in the first canvas.

Accordingly, in a case that graphic elements within or adjacent to the display region of the first canvas are drawn, this disclosure also supports a user to dynamically switch the current display region on the terminal interface, so as to display more graphic elements at other element positions in the first canvas, enabling the user to view graphic elements at all element positions on the first canvas. In particular, the user does not need to perceive the existence of the first canvas.

FIG. 12 is a schematic flowchart of a method for modifying a graphic element according to an aspect of this disclosure. As shown in FIG. 12, the method may include:

Operation S301: Obtain, if a modification operation triggered for a third graphic element displayed on a second canvas is received, an element modification region in a first canvas according to the modification operation.

In an implementation, a third graphic element may be any graphic element displayed on the second canvas. There may be one or more third graphic elements. A user may perform a modification operation on the displayed third graphic element in the second canvas, to modify the third graphic element. For example, when the user drags a position of an entire chart, the modified third graphic element may include each graphic element included in the dragged chart. Alternatively, only a single third graphic element may be modified.

The modification operation triggered on the third graphic element may be configured to modify a position, a display style, a size, or contained data of the third graphic element. A modification type may be determined according to an actual application scenario.

A position region where a graphic element is located in the first canvas may alternatively be a rectangular region. The rectangular region may be a minimum region where the graphic element is located in the first canvas, namely, a rectangular region just capable of accommodating the graphic element. Therefore, an element position where a graphic element is located in the first canvas may be configured to indicate the position region (or the rectangular region) where the graphic element is located in the first canvas.

Therefore, if the data processing device receives a modification operation triggered on the third graphic element displayed on the second canvas, the data processing device may first obtain an element modification region in the first canvas according to the modification operation. The element modification region is a modified region. The element modification region may be referred to as a dirty region. The dirty region may be a rectangular region. Therefore, the dirty region may be referred to as a dirty rectangle. In some aspects, there may be one or more element modification regions. The one or more element modification regions may constitute a dirty rectangle list.

The process of obtaining an element modification region in the first canvas according to the modification operation on the third graphic element may include: if the modification operation does not indicate modifying an element position of the third graphic element (or a position region where the third graphic element is located), an element region where the third graphic element is located in the first canvas when the modification operation is triggered may be taken as the foregoing element modification region.

If the modification operation indicates modifying the element position of the third graphic element, both an element region where the third graphic element is located in the first canvas when the modification operation is triggered (or an element region where the third graphic element is located before modification) and an element region to which the third graphic element is to be modified in the first canvas (or an element region to which the third graphic element needs to be modified) may be taken as element modification regions, because both the element region where the third graphic element is located before modification and the element region to which modification needs to be performed need to be correspondingly modified.

Accordingly, one third graphic element may correspond to one or two element modification regions. If there are a plurality of third graphic elements, the plurality of third graphic elements may correspond to a plurality of element modification regions.

Operation S302: Redraw a graphic element within the element modification region in the first canvas according to the modification operation.

In an implementation, the data processing device traverses each element modification region (e.g., each dirty rectangle in the dirty rectangle list), and redraws graphic elements within each element modification region in the first canvas according to the modification operation, which may be understood as redrawing the element modification regions. Corresponding drawing may be performed within the element modification region according to a modification type required by the modification operation on the third graphic element, to obtain redrawn graphic elements within the element modification region.

For example, the redrawn third graphic element may be a third graphic element modified according to the modification operation. For another example, if the third graphic element needs to be moved from an original element position to another element position, the third graphic element within the element region at the original element position may be cleared.

In another feasible implementation, if there are a plurality of element modification regions, the data processing device may further merge adjacent element modification regions among the plurality of element modification regions to obtain at least one merged modification region, and then redraw each obtained merged modification region. In some aspects, the adjacent element modification regions may refer to element modification regions with a distance less than or equal to a set distance threshold. If there are plurality of adjacent element modification regions, the plurality of adjacent element modification regions may be merged together to obtain a corresponding merged modification region.

The merged modification region may alternatively be a rectangular region, and the merged modification region is a minimum rectangular region capable of simultaneously accommodating each merged element modification region. For example, if element modification region q1 is adjacent to element modification region q2 and element modification region q2 is adjacent to element modification region q3, element modification region q1, element modification region q2, and element modification region q3 may be merged together to obtain a merged modification region capable of simultaneously accommodating element modification region q1, element modification region q2, and element modification region q3.

For another example, if element modification region q4 is adjacent to element modification region q5, element modification region q4 and element modification region q5 may be merged to obtain a minimum rectangular region capable of simultaneously accommodating element modification region q4 and element modification region q5, namely, a corresponding merged modification region.

For another example, if element modification region q6 is not adjacent to any other element modification region, element modification region q6 may be taken as a special merged modification region thereof. In such a case, the merged modification region may be an element region where element modification region q6 is located in the first canvas.

Through the foregoing process, at least one merged modification region may be obtained. One merged modification region may be obtained by merging at least two element modification regions, or one merged modification region may be an element modification region that is not adjacent to any other element modification region.

Further, the data processing device may redraw the graphic elements within each obtained merged modification region in the first canvas according to the modification operation. In an example, the data processing device may redraw each merged modification region, to obtain redrawn graphic elements in each merged modification region.

Other regions outside the element modification regions may be introduced when merging the element modification regions, so that graphic elements within the introduced other regions also need to be redrawn. Therefore, during the actual merging of the element modification regions, relevant restrictions may be imposed on the merging processing operation to enhance performance of graphic element drawing. For example, the distance threshold may be set to be relatively small. For another example, a maximum number of element modification regions merged together may be limited. For example, one merged modification region may be obtained by merging at most three element modification regions.

In the foregoing process, by merging a plurality of element modification regions into a smaller number of merged modification regions, the data processing device may process (e.g., recognize and draw separately) a smaller number of modification regions (e.g., merged modification regions), thereby improving performance of the data processing device in redrawing graphic elements within the modification regions.

Operation S303: Display the redrawn graphic element and original data corresponding to the redrawn graphic element in the second canvas.

In an implementation, the data processing device may display the redrawn graphic elements and original data corresponding to the redrawn graphic elements (or original data having an association relationship with the redrawn graphic elements) at corresponding positions in the second canvas, so as to implement corresponding modification on the third graphic element by a user and allow the user to view the modification.

An arrangement manner of the graphic elements drawn within the display region of the first canvas is consistent with a display manner of the graphic elements drawn within the display region on the second canvas at corresponding positions.

Through the foregoing process, in a dirty rectangle manner, this disclosure may redraw graphic elements that are changed (or modified), without redrawing all graphic elements within the entire display region, thereby improving efficiency and performance of drawing and displaying graphic elements when the graphic elements are modified.

By adopting one or more of the foregoing methods provided in this disclosure, in a face of a visualization scenario of large data, multiple dimensions, and multiple facets, a large number of charts may be drawn within a short time without a lag phenomenon, and a limit of a browser canvas in pixel drawing is addressed. Therefore, superior performance may be achieved in a scenario of chart drawing and display, and a user may perform data analysis through the charts more smoothly.

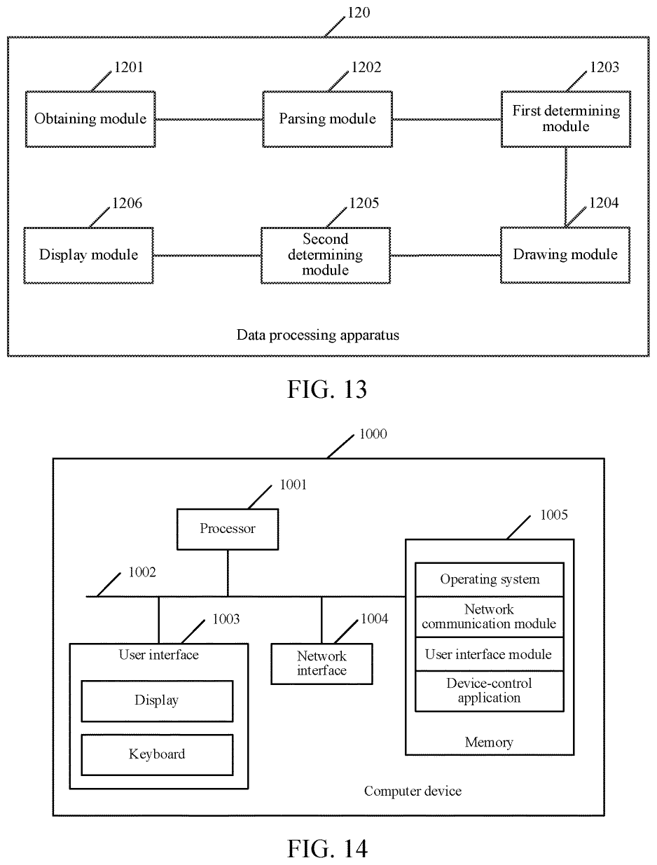

FIG. 13 is a schematic structural diagram of a data processing apparatus according to an aspect of this disclosure. As shown in FIG. 13, a data processing apparatus 120 may include: an obtaining module 1201, a parsing module 1202, a first determining module 1203, a drawing module 1204, a second determining module 1205, and a display module 1206.

The obtaining module 1201 is configured to obtain an original data set, the original data set including at least one item of original data.

The parsing module 1202 is configured to parse, based on a first canvas, a graphic element set from the original data set, the graphic element set including a plurality of graphic elements and first element positions respectively allocated to the plurality of graphic elements in the first canvas, and a first canvas size of the first canvas being dynamically adjustable according to the plurality of graphic elements.

The first determining module 1203 is configured to determine a display region in the first canvas, and screen for a first graphic element from the graphic element set based on the display region and the first element positions respectively corresponding to the plurality of graphic elements, the first element position corresponding to the first graphic element satisfying a preset position relationship with the display region.

The drawing module 1204 is configured to draw the first graphic element in the first canvas based on the first element position corresponding to the first graphic element.

The second determining module 1205 is configured to take the first graphic element located within the display region as a second graphic element, and determine target original data corresponding to the second graphic element from the original data set.

The display module 1206 is configured to display the target original data in a second canvas by using the second graphic element, a second canvas size of the second canvas corresponding to the display region.

In some aspects, a size of the first canvas is dynamically adjustable to a target size, the target size being a size capable of accommodating the graphic element set.

A size of the display region is less than or equal to the target size, and the size of the display region is equal to a size of the second canvas.

In an implementation, the manner of parsing, by the parsing module 1202, a graphic element set from the original data set based on a first canvas includes:
obtaining a target type of a chart required for displaying original data in the original data set, and obtaining configuration data of the chart of the target type; and
parsing the configuration data based on the original data set and the first canvas to obtain the graphic element set, the graphic element set configured to draw the chart of the target type.

In an implementation, if one graphic element in the graphic element set is parsed based on one or more items of original data in the original data set, the graphic element has an association relationship with the one or more items of original data.

The manner of determining, by the second determining module 1205, target original data corresponding to the second graphic element from the original data set includes:
determining, from the original data set, original data having an association relationship with the second graphic element as the target original data corresponding to the second graphic element.

In an implementation, the second canvas is displayed on a terminal interface, the terminal interface including a first scroll bar and a second scroll bar, the first scroll bar being configured to perform a scroll change on the display region in a first direction, the second scroll bar being configured to perform a scroll change on the display region in a second direction, a total scroll distance of the first scroll bar being equal to a size of the first canvas in the first direction, and a total scroll distance of the second scroll bar being equal to a size of the first canvas in the second direction.

The manner of determining, by the first determining module 1203, a display region in the first canvas includes:
obtaining a first distance scrolled by an operation of the first scroll bar and a second distance scrolled by an operation of the second scroll bar; and
determining the display region in the first canvas based on the first distance and the second distance.

In an implementation, the first canvas has a coordinate system, the coordinate system including a first coordinate axis in the first direction and a second coordinate axis in the second direction. The manner of determining, by the first determining module 1203, the display region in the first canvas based on the first distance and the second distance includes:
obtaining a first coordinate value based on the first distance, and obtaining a second coordinate value based on the second distance, the first coordinate value being configured to indicate a first axial position of the display region in the first canvas on the first coordinate axis, and the second coordinate value being configured to indicate a second axial position of the display region in the first canvas on the second coordinate axis; and
constructing a target coordinate in the coordinate system based on the first coordinate value and the second coordinate value.

The position of the display region in the first canvas is determined by a combination of the target coordinate and the size of the display region.

In an implementation, the manner of obtaining, by the first determining module 1203, a first coordinate value based on the first distance and obtaining a second coordinate value based on the second distance includes:
obtaining a first initial coordinate value of the display region in the first direction, and performing summation processing on the first initial coordinate value and the first distance to obtain the first coordinate value; and
obtaining a second initial coordinate value of the display region in the second direction, and performing summation processing on the second initial coordinate value and the second distance to obtain the second coordinate value.

In an implementation, the display region is a rectangular region, the target coordinate is a position coordinate of any vertex of the display region in the first canvas, the first direction is a horizontal direction, the second direction is a vertical direction, and the target size includes a length of the display region in the horizontal direction and a width in the vertical direction.

The display region is a rectangular region determined on the first canvas based on the position coordinate of the any vertex, the length in the horizontal direction, and the width in the vertical direction.

In an implementation, the first canvas is divided into M layers of sub-canvases according to a tree structure, M being a positive integer, any sub-canvas of an i^{th} layer being divided into N sub-canvases of an (i+1)^{th} layer, the N sub-canvases each being a next sub-canvas of the any sub-canvas, M, i and N each being a positive integer, and i being less than M.

The manner of screening, by the first determining module 1203, for a first graphic element from the graphic element set based on the display region and the first element positions respectively corresponding to the plurality of graphic elements includes:
sequentially traversing the M layers of sub-canvases in the tree structure from top to bottom; and
screening for the first graphic element from the graphic element set based on the traversed sub-canvases, the display region, and the first element positions respectively corresponding to the plurality of graphic elements.

In an implementation, the manner of screening, by the first determining module 1203, for the first graphic element from the graphic element set based on the traversed sub-canvases, the display region, and the first element positions respectively corresponding to the plurality of graphic elements includes:
performing an intersection calculation between the traversed sub-canvases and the display region; stopping, if any traversed sub-canvas of the i^{th} layer does not intersect with the display region, traversal of a next sub-canvas of the any sub-canvas;
continuing, if any traversed sub-canvas of the i^{th} layer intersects with the display region, to traverse a next sub-canvas of the any sub-canvas;
taking a traversed sub-canvas in an M^{th} layer of sub-canvas, intersecting with the display region, as a to-be-drawn sub-canvas; and
determining, as the first graphic element, all graphic elements corresponding to the first element positions located within the to-be-drawn sub-canvas in the graphic element set.

The preset position relationship includes: in the M^{th} layer of sub-canvas, a sub-canvas where the first graphic element is located intersects with the display region.

In an implementation, the position of the display region in the first canvas supports a dynamic change. The manner of determining, by the first determining module 1203, a display region in the first canvas includes:
determining a target display region in the first canvas, the target display region being a current display region in the first canvas.

The manner of screening, by the first determining module 1203, for a first graphic element from the graphic element set based on the display region and the first element positions respectively corresponding to the plurality of graphic elements includes:
screening, if the target display region has a previous display region, for the first graphic element from the graphic element set based on the target display region, the previous display region, and the first element positions respectively corresponding to the plurality of graphic elements.

The previous display region is a display region in the first canvas before the display region is changed to the target display region.

In an implementation, the manner of screening, by the first determining module 1203, for the first graphic element from the graphic element set based on the target display region, the previous display region, and the first element positions respectively corresponding to the plurality of graphic elements includes:
obtaining an overlapping region between the target display region and the previous display region, and determining a region of the target display region other than the overlapping region as an update region; and
screening for the first graphic element from the graphic element set based on the update region and the first element positions respectively corresponding to the plurality of graphic elements.

In an implementation, the manner of displaying, by the display module 1206, the target original data in a second canvas by using the second graphic element includes:
displaying the target original data in the second canvas by using the second graphic element located within the update region; and
displaying, in the second canvas, original data corresponding to a drawn graphic element in the overlapping region of the previous display region by using the drawn graphic element.

In an implementation, the data processing apparatus 120 is further configured to: obtain, if a modification operation triggered for a third graphic element displayed on the second canvas is received, an element modification region in the first canvas according to the modification operation;
redraw a graphic element within the element modification region in the first canvas according to the modification operation; and
display the redrawn graphic element and original data corresponding to the redrawn graphic element in the second canvas.

In an implementation, the manner of obtaining, by the data processing apparatus 120, an element modification region in the first canvas according to the modification operation includes:
determining, if the modification operation does not indicate modifying an element position of the third graphic element, an element region where the third graphic element is located in the first canvas as the element modification region; and
determining, if the modification operation indicates modifying an element position of the third graphic element, an element region where the third graphic element is located in the first canvas and an element region to which the third graphic element is to be modified in the first canvas as the element modification region.

In an implementation, the manner of redrawing, by the data processing apparatus 120, a graphic element within the element modification region in the first canvas according to the modification operation includes:
merging, if there are a plurality of element modification regions, adjacent element modification regions among the plurality of element modification regions to obtain at least one merged modification region; and
redrawing a graphic element within the at least one merged modification region in the first canvas according to the modification operation.

According to an aspect of this disclosure, the operations in the data processing method shown in FIG. 3 may be performed by the modules of the data processing apparatus 120 shown in FIG. 13. For example, operation S101 shown in FIG. 3 may be performed by the obtaining module 1201 in FIG. 13, operation S102 shown in FIG. 3 may be performed by the parsing module 1202 in FIG. 13, operation S103 shown in FIG. 3 may be performed by the first determining module 1203 in FIG. 13, operation S104 shown in FIG. 3 may be performed by the drawing module 1204 in FIG. 13, operation S105 shown in FIG. 3 may be performed by the second determining module 1205 in FIG. 13, and operation S106 shown in FIG. 3 may be performed by the display module 1206 in FIG. 13.

In this disclosure, graphic elements may be drawn on a first canvas. Since a size of the first canvas is dynamically adjustable, graphic elements of any number to be drawn may be accommodated on the dynamically sized first canvas, so that the number of graphic elements to be drawn in this disclosure may be unlimited. In addition, the first canvas may have a display region. In this disclosure, a first graphic element to be currently drawn may be screened from a full graphic element set according to the display region, where a first element position corresponding to the first graphic element in the first canvas satisfies a preset position relationship with the display region. In this way, only the first graphic element associated with the display region needs to be drawn subsequently, without drawing all graphic elements in the graphic element set in a single operation. Then, in a second canvas actually used for displaying original data, target original data may be displayed via a drawn second graphic element located within the display region. Therefore, the efficiency of drawing graphic elements is improved, and the timeliness of displaying graphic elements is enhanced. In some aspects, the methods provided in this disclosure may improve the performance of drawing and displaying graphic elements.

According to an aspect of this disclosure, modules in the data processing apparatus 120 shown in FIG. 13 may be separately or wholly combined into one or several units, or one (or more) of the units herein may further be divided into a plurality of subunits of smaller functions. In this way, the same operations may be implemented, and implementation of the technical effects of the aspects of this disclosure is not affected. The foregoing modules are divided based on logical functions. In an actual application, a function of one module may be implemented by a plurality of units, or functions of a plurality of modules are implemented by one unit. In other aspects of this disclosure, the data processing apparatus 120 may also include other units. During actual application, the functions may be cooperatively implemented by other units and may be cooperatively implemented by a plurality of units.

In the aspects of this disclosure, the term “module” or “unit” refers to a computer program having a predetermined function or a part of a computer program, and works together with other relevant parts to achieve a predetermined objective, and may be all or partially implemented by using software, hardware (e.g., processing circuitry or a memory), or a combination thereof. Similarly, one processor (or a plurality of processors or memories) may be configured to implement one or more modules or units. In addition, each module or unit may be a part of an overall module or unit including a function of the module or unit.

According to an aspect of this disclosure, a computer program that can perform operations in the corresponding method shown in aspects of this disclosure may be run on a general computer device (the computer device may include processing elements and storage elements such as a central processing unit (CPU), a random access memory (RAM), and a read-only memory (ROM)), to construct the data processing apparatus 120 shown in FIG. 13. The computer program may be recorded in, for example, a non-transitory computer-readable recording medium, and may be loaded into the foregoing computer device by using the non-transitory computer-readable recording medium, and run therein.

FIG. 14 is a schematic structural diagram of a computer device according to an aspect of this disclosure. As shown in FIG. 14, a computer device 1000 may include a processor 1001, a network interface 1004, and a memory 1005. In addition, in some aspects, the computer device 1000 may further include: a user interface 1003 and at least one communication bus 1002. The communication bus 1002 is configured to implement connection and communication between the components. The user interface 1003 may include a display and a keyboard. In some aspects, the user interface 1003 may further include a standard wired interface and a standard wireless interface. In some aspects, the network interface 1004 may include a standard wired interface and a wireless interface (e.g., a Wi-Fi interface). The memory 1005 may be a high-speed RAM, or may be a non-volatile memory, for example, at least one magnetic disk memory. In some aspects, the memory 1005 may be at least one storage apparatus located away from the foregoing processor 1001. As shown in FIG. 14, the memory 1005 used as a computer storage medium may include an operating system, a network communication module, a user interface module, and a device-control application.

In the computer device 1000 shown in FIG. 14, the network interface 1004 may provide a network communication function. The user interface 1003 is mainly an interface for providing input for a user. The processor 1001 may be configured to call the device-control application stored in the memory 1005, for:
obtaining an original data set, the original data set including at least one item of original data;
parsing, based on a first canvas, a graphic element set from the original data set, the graphic element set including a plurality of graphic elements and first element positions respectively allocated to the plurality of graphic elements in the first canvas, and a first canvas size of the first canvas being dynamically adjustable according to the plurality of graphic elements;
determining a display region in the first canvas, and screening for a first graphic element from the graphic element set based on the display region and the first element positions respectively corresponding to the plurality of graphic elements, the first element position corresponding to the first graphic element satisfying a preset position relationship with the display region;
drawing the first graphic element in the first canvas based on the first element position corresponding to the first graphic element;
taking the first graphic element located within the display region as a second graphic element, and determining target original data corresponding to the second graphic element from the original data set; and
displaying the target original data in a second canvas by using the second graphic element, a second canvas size of the second canvas corresponding to the display region.

The computer device 1000 described in the aspects of this disclosure may perform descriptions of the foregoing data processing method in the aspects of this disclosure, or may perform descriptions of the foregoing data processing apparatus 120 in the aspect corresponding to FIG. 13. Further details are not described herein. In addition, the description of beneficial effects of the same method are not described herein.

In addition, this disclosure further provides a non-transitory computer-readable storage medium. The non-transitory computer-readable storage medium has a computer program stored therein. When executing the computer program, a processor can perform the descriptions of the data processing method in the aspects of this disclosure. Therefore, further details are not described herein. In addition, the description of beneficial effects of the same method are not described herein.

As an example, the foregoing computer program may be deployed to be executed on one computer device, on a plurality of computer devices located at one place, or on a plurality of computer devices distributed at a plurality of places and interconnected through a communication network. The plurality of computer devices distributed at the plurality of places and interconnected through the communication network may form a blockchain system.

The foregoing non-transitory computer-readable storage medium may be an internal storage unit of the foregoing computer device, such as a hard disk or an internal memory of the computer device. The non-transitory computer-readable storage medium may alternatively be an external storage device of the computer device, for example, a removable hard disk drive, a smart media card (SMC), a secure digital (SD) card, or a flash card equipped on the computer device. Further, the non-transitory computer-readable storage medium may include both an internal storage unit and an external storage device of the computer device. The non-transitory computer-readable storage medium is configured to store the computer program and other programs and data required by the computer device. The non-transitory computer-readable storage medium may be further configured to temporarily store data that has been or is to be outputted.

This disclosure provides a computer program product. The computer program product includes a computer program, and the computer program is stored in a non-transitory computer-readable storage medium. A processor of a computer device reads the computer program from the non-transitory computer-readable storage medium, and the processor executes the computer program, to cause the computer device to perform the descriptions of the foregoing data processing method in the aspects of this disclosure. Therefore, further details are not described herein. In addition, the description of beneficial effects of the same method are not described herein. For technical details that are not disclosed in the aspects of the non-transitory computer-readable storage medium included in this disclosure, refer to the descriptions about the method aspects of this disclosure.

The terms “first”, “second”, and the like in the specification, the claims, and the accompanying drawings of the aspects of this disclosure are intended to distinguish between different objects, instead of describing a particular sequence. Furthermore, the term “include” and any variation thereof are intended to cover a non-exclusive inclusion. For example, processes, methods, apparatuses, products, or devices including a series of operations or units are not limited to the listed operations or modules, but instead, include operations or modules not listed in some aspects, or include other operations or units inherent in these processes, methods, apparatuses, products, or devices in some aspects.

A person of ordinary skill in the art may be aware that, in combination with one or more examples described in this disclosure, units and algorithm operations may be implemented by electronic hardware, computer software, or a combination thereof. To describe the interchangeability between the hardware and the software, the foregoing has described compositions and operations of each example according to functions. Whether the functions are executed in a mode of hardware or software depends on particular applications and design constraint conditions of the technical solutions. A person skilled in the art may use different methods to implement the described functions for each particular application within the scope of this disclosure.

What is disclosed above is merely example aspects of this disclosure, and is not intended to limit the scope of this disclosure. Therefore, variations or modifications made in accordance with this disclosure shall fall within the scope of this disclosure.

What is claimed is:

1. A data processing method, the method comprising:
obtaining an original data set;
obtaining a graphic element set based on the original data set, the graphic element set including a plurality of graphic elements and corresponding element positions of the plurality of graphic elements in a first canvas, and a first canvas size of the first canvas being adjustable based on the plurality of graphic elements;
determining a display region in the first canvas;
determining, by processing circuitry, first one or more graphic elements from the graphic element set based on the corresponding one or more element positions of the first one or more graphic elements satisfying a preset position relationship with the display region;
drawing the first one or more graphic elements on the first canvas based on the corresponding one or more element positions of the first one or more graphic elements;
determining, by the processing circuitry, second one or more graphic elements within the display region based on the first one or more graphic elements;
obtaining target original data corresponding to the second one or more graphic elements from the original data set; and
displaying the target original data on a second canvas based on the second one or more graphic elements, a second canvas size of the second canvas corresponding to the display region.

2. The method according to claim 1, wherein
a size of the first canvas is adjustable to a target size that is capable of accommodating the graphic element set,
a size of the display region is less than or equal to the target size, and
the size of the display region is equal to a size of the second canvas.

3. The method according to claim 1, wherein the obtaining the graphic element set based on the original data set comprises:
obtaining a target type of a chart configured to display a subset of the original data set;
obtaining configuration data of the chart of the target type; and
parsing the configuration data based on the original data set and the first canvas to obtain the graphic element set, the graphic element set corresponding to drawing the chart of the target type.

4. The method according to claim 1, wherein
each of the second one or more graphic elements has a respective association relationship with one or more items of original data when the corresponding one of the second one or more graphic elements is obtained based on the original data set, and
the determining the target original data corresponding to the second graphic element from the original data set includes
determining, for each one of the second one or more graphic elements from the original data set, the respective one or more data items as the target original data corresponding to the corresponding one of the second one or more graphic elements.

5. The method according to claim 1, wherein
the second canvas is displayed on a terminal interface, the terminal interface including a first scroll bar and a second scroll bar, the first scroll bar being configured to perform a scroll change on the display region in a first direction, the second scroll bar being configured to perform a scroll change on the display region in a second direction, a total scroll distance of the first scroll bar being equal to a size of the first canvas in the first direction, and a total scroll distance of the second scroll bar being equal to a size of the first canvas in the second direction, and
the determining the display region in the first canvas includes:
obtaining a first distance scrolled by an operation of the first scroll bar and a second distance scrolled by an operation of the second scroll bar; and
determining the display region in the first canvas based on the first distance and the second distance.

6. The method according to claim 5, wherein
the first canvas has a coordinate system, the coordinate system including a first coordinate axis in the first direction and a second coordinate axis in the second direction, and
the determining the display region in the first canvas based on the first distance and the second distance includes:
obtaining a first coordinate value based on the first distance, and obtaining a second coordinate value based on the second distance, the first coordinate value indicating a first axial position of the display region in the first canvas on the first coordinate axis, and the second coordinate value indicating a second axial position of the display region in the first canvas on the second coordinate axis; and
constructing a target coordinate in the coordinate system based on the first coordinate value and the second coordinate value,
the position of the display region in the first canvas being determined based on the target coordinate and the size of the display region.

7. The method according to claim 6, wherein the obtaining the first coordinate value and the obtaining the second coordinate value based on the second distance include:
obtaining a first initial coordinate value of the display region in the first direction, and performing summation processing on the first initial coordinate value and the first distance to obtain the first coordinate value; and
obtaining a second initial coordinate value of the display region in the second direction, and performing summation processing on the second initial coordinate value and the second distance to obtain the second coordinate value.

8. The method according to claim 6, wherein
the display region is a rectangular region,
the target coordinate is a position coordinate of a vertex of the display region in the first canvas,
the first direction is a horizontal direction,
the second direction is a vertical direction, and
the size of the display region includes a length of the display region in the horizontal direction and a width in the vertical direction.

9. The method according to claim 1, wherein
the first canvas is divided into M layers of sub-canvases based on a tree structure, each sub-canvas of an i^{th} layer being divided into N sub-canvases of an (i+1)^{th} layer, M being a positive integer, N being a positive integer, and i being a positive integer less than M, and
the determining the first one or more graphic elements from the graphic element set includes:
sequentially traversing the M layers of sub-canvases in the tree structure from top to bottom; and
screening for the first one or more graphic elements from the graphic element set based on the traversed sub-canvases, the display region, and the corresponding element positions of the plurality of graphic elements.

10. The method according to claim 9, wherein
the preset position relationship corresponding to each one of the one or more first graphic elements is located in a sub-canvas in an M^{th} layer of the M layers of sub-canvases that intersects with the display region, and
the screening for the first one or more graphic elements from the graphic element set comprises:
performing an intersection calculation between the traversed sub-canvases and the display region;
stopping, when a currently traversed sub-canvas of the i^{th} layer does not intersect with the display region, traversal of a next-layer sub-canvas of the currently traversed sub-canvas;
continuing, when the currently traversed sub-canvas of the i^{th} layer intersects with the display region, to traverse the next-layer sub-canvas of the currently traversed sub-canvas;
taking a traversed sub-canvas in the M^{th} layer of the M layers of sub-canvases that intersects with the display region as a to-be-drawn sub-canvas; and
including all graphic elements in the graphic element set with the corresponding element positions within the to-be-drawn sub-canvas in the first one or more graphic elements.

11. The method according to claim 1, wherein
the determined display region switches from a previous display region to a current display region, and
the determining the first one or more graphic elements from the graphic element set comprises:
screening for the first one or more graphic elements from the graphic element set based on the current display region, the previous display region, and the corresponding element positions of the plurality of graphic elements.

12. The method according to claim 11, wherein the screening for the first one or more graphic elements from the graphic element set comprises:
obtaining an overlapping region between the current display region and the previous display region;
determining a region of the current display region other than the overlapping region as an update region; and
screening for the first one or more graphic elements from the graphic element set based on the update region and the corresponding element positions of the plurality of graphic elements.

13. The method according to claim 12, wherein the displaying the target original data on the second canvas comprises:
displaying the target original data on the second canvas based on the second one or more graphic elements located within the update region; and
displaying, on the second canvas, drawn original data corresponding to one or more drawn graphic elements in the overlapping region of the previous display region based on the one or more drawn graphic elements.

14. The method according to claim 1, further comprising:
obtaining, when a modification operation for a third graphic element displayed on the second canvas is received, one or more element modification regions in the first canvas based on the modification operation;
redrawing a graphic element within the one or more element modification regions in the first canvas based on the modification operation; and
displaying the redrawn graphic element and original data corresponding to the redrawn graphic element in the second canvas.

15. The method according to claim 14, wherein the obtaining the one or more element modification regions comprises:
determining, when the modification operation does not indicate modifying an element position of the third graphic element, an element region in which the third graphic element is located in the first canvas as one of the one or more element modification regions; and
determining, when the modification operation indicates modifying the element position of the third graphic element, the element region in which the third graphic element is located in the first canvas and an element region to which the third graphic element is to be modified in the first canvas as two of the one or more element modification regions.

16. The method according to claim 14, wherein the redrawing the graphic element within the element modification region in the first canvas comprises:
merging, when the one or more element modification regions correspond to a plurality of element modification regions, adjacent element modification regions among the plurality of element modification regions to obtain at least one merged modification region; and
redrawing a graphic element within the at least one merged modification region in the first canvas based on the modification operation.

17. An apparatus for data processing, comprising:
processing circuitry configured to:
obtain an original data set;
obtain a graphic element set based on the original data set, the graphic element set including a plurality of graphic elements and corresponding element positions of the plurality of graphic elements in a first canvas, and a first canvas size of the first canvas being adjustable based on the plurality of graphic elements;
determine a display region in the first canvas;
determine first one or more graphic elements from the graphic element set based on the corresponding one or more element positions of the first one or more graphic elements satisfying a preset position relationship with the display region;
draw the first one or more graphic elements on the first canvas based on the corresponding one or more element positions of the first one or more graphic elements;
determine second one or more graphic elements within the display region based on the first one or more graphic elements;
obtain target original data corresponding to the second one or more graphic elements from the original data set; and
display the target original data on a second canvas based on the second one or more graphic elements, a second canvas size of the second canvas corresponding to the display region.

18. The apparatus according to claim 17, wherein
a size of the first canvas is adjustable to a target size that is capable of accommodating the graphic element set,
a size of the display region is less than or equal to the target size, and
the size of the display region is equal to a size of the second canvas.

19. The apparatus according to claim 17, wherein the processing circuitry is configured to:
obtain a target type of a chart configured to display a subset of the original data set;
obtain configuration data of the chart of the target type; and
parse the configuration data based on the original data set and the first canvas to obtain the graphic element set, the graphic element set corresponding to drawing the chart of the target type.

20. A non-transitory computer-readable storage medium storing instructions, which when executed by a processor, cause the processor to perform a data processing method, the method comprising:
obtaining an original data set;
obtaining a graphic element set based on the original data set, the graphic element set including a plurality of graphic elements and corresponding element positions of the plurality of graphic elements in a first canvas, and a first canvas size of the first canvas being adjustable based on the plurality of graphic elements;
determining a display region in the first canvas;
determining first one or more graphic elements from the graphic element set based on the corresponding one or more element positions of the first one or more graphic elements satisfying a preset position relationship with the display region;
drawing the first one or more graphic elements on the first canvas based on the corresponding one or more element positions of the first one or more graphic elements;
determining second one or more graphic elements within the display region based on the first one or more graphic elements;
obtaining target original data corresponding to the second one or more graphic elements from the original data set; and
displaying the target original data on a second canvas based on the second one or more graphic elements, a second canvas size of the second canvas corresponding to the display region.
